(19) United States
(12) Patent Application Publication
(10) Pub. No.: US 2026/0030042 A1
(43) Pub. Date: Jan. 29, 2026

(54) SOFTWARE WIZARDS PROGRAMMED FOR GENERATING CUSTOMIZED PROPOSAL REPORTS

(71) Applicant: Index Pro LLC, Austin, TX (US)

(72) Inventors: Daniel Kushkuley, Austin, TX (US); Ron Kushkuley, Austin, TX (US); Basil Qunibi, Austin, TX (US)

(21) Appl. No.: 19/343,261

(22) Filed: Sep. 29, 2025

Related U.S. Application Data
(63) Continuation of application No. PCT/US24/23199, filed on Apr. 5, 2024.
(60) Provisional application No. 63/457,291, filed on Apr. 5, 2023.

(51) Int. Cl. G06F 9/451; G06F 3/0482; G06F 40/166

(52) U.S. Cl. CPC G06F 9/453; G06F 40/166; G06F 3/0482

(57) ABSTRACT

This disclosure solves various technological problems referenced above by enabling various improvements to functioning of computers (e.g., software wizards) where the second person is computationally enabled to enter the set of negative preferences to be included in the set of answers based on which the customized proposal report is generated by the application program, especially when the set of questions or the set of questions has the logical hierarchy or the informational interdependency.

### CROSS-REFERENCE TO RELATED PATENT APPLICATIONS

This patent application is a Continuation of PCT Patent Application PCT/US2024/023199 filed 5 Apr. 2024; which claims a benefit of priority to U.S. Provisional Patent Application 63/457,291 filed 5 Apr. 2023; each of which is incorporated by reference herein in its entirety for all purposes.

### TECHNICAL FIELD

This disclosure relates to software wizards programmed for generating customized proposal reports.

### BACKGROUND

Conventionally, to generate a customized proposal report (e.g., a data file, a Hyper Text Markup Language (HTML) file, a Portable Document Format (PDF) file) for a service (e.g., an electronic trading service, a High Frequency Trading (HFT) service, a document processing service), a first person (e.g., a service provider representative) may provide a paper form (e.g., a printout, a tactile medium) of a questionnaire with a set of questions to a second person (e.g., a service receiver representative). The second person may answer the set of questions by writing a set of answers (e.g., a set of alphanumeric phrases, a set of listed selections) on the paper form. The first person may input (e.g., by typing, selecting, scanning) the set of answers from the paper form into a computing terminal (e.g., a desktop computer, a tablet computer) operated by the first person and accessing an application program (e.g., a Customer Relationship Management (CRM) application program), whether local to or remote from the computing terminal, for the application program to consider the set of answers, as input, and generate the customized proposal report based on the set of answers, as input, for output (e.g., by printing, emailing) to the second person. Alternatively, the second person may operate the computing terminal to access a virtual form (e.g., a webpage, a mobile application program) of the questionnaire provided by the application program, whether local to or remote from the computing terminal, and input (e.g., by typing, selecting) the set of answers to the set of questions into the application program through the computing terminal, for the application program to consider the set of answers, as input, and generate the customized proposal report based on the set of answers, as input, for output to the second person. Although these approaches to generating the customized proposal report are suitable in many situations, there are still some situations where these approaches are technologically inadequate and suffer from various technological drawbacks. For example, these approaches to generating the customized proposal report do not enable any computational entry of a set of negative preferences to be included in the set of answers based on which the customized proposal report is generated by the application program. These technological problems are further compounded and become more complicated when the set of questions or the set of answers has a logical hierarchy or an informational interdependency.

### SUMMARY

This disclosure solves various technological problems referenced above by enabling various improvements to functioning of computers (e.g., software wizards) where the second person is computationally enabled to enter the set of negative preferences to be included in the set of answers based on which the customized proposal report is generated by the application program, especially when the set of questions or the set of questions has the logical hierarchy or the informational interdependency.

### DESCRIPTION OF DRAWINGS

FIG. 1 shows a screenshot of an embodiment of a screen programmed for securely accessing a web portal by entering an email address and a password each for a profile according to this disclosure.

FIG. 2 shows a screenshot of an embodiment of a user interface of the web portal being securely accessed after entering the email address and the password each for the profile according to this disclosure.

FIG. 3 shows a screenshot of an embodiment of a header of the user interface of the web portal according to this disclosure.

FIG. 4 shows a screenshot of an embodiment of a menu of the user interface to enter identifying profile information according to this disclosure.

FIG. 5 shows a screenshot of an embodiment of a menu of the user interface to select an account type according to this disclosure.

FIG. 6 shows a screenshot of an embodiment of a menu of the user interface to input account information according to this disclosure.

FIG. 7 shows a screenshot of an embodiment of a prompt or warning for the menu of the user interface to enter identifying profile information according to this disclosure.

FIG. 8 shows a screenshot of an embodiment of a screen depicting a status dashboard according to this disclosure.

FIG. 9 shows a screenshot of an embodiment of a prompt to add an account number presented over the screen depicting the status dashboard according to this disclosure.

FIG. 10 shows a screenshot of an embodiment of a screen depicting a status dashboard with the account number added according to this disclosure.

FIG. 11 shows a screenshot of an embodiment of a prompt to input a strategy identifier presented over the screen depicting the status dashboard according to this disclosure.

FIG. 12 shows a screenshot of an embodiment of the prompt with the strategy identifier input as presented over the screen depicting the status dashboard according to this disclosure.

FIG. 13 shows a screenshot of an embodiment of a screen depicting a status dashboard where the account number and the strategy identifier each as input are presented according to this disclosure.

FIG. 14 shows a screenshot of an embodiment of a screen depicting a list of hyperlinks named with a list of strategy identifiers presented in a tabular format according to this disclosure.

FIG. 15 shows a screenshot of an embodiment of a screen depicting a first step of a software wizard according to this disclosure.

FIG. 16 shows a screenshot of an embodiment of a prompt presented over the screen of FIG. 15 to create an allocation model from a set of index identifiers according to this disclosure.

FIG. 17 shows a screenshot of an embodiment of a prompt presented over the screen of FIG. 15 to create an allocation model from a set of fund identifiers according to this disclosure.

FIG. 18 shows a screenshot of an embodiment of a prompt presented over the screen of FIG. 15 where an index identifier and a fund identifier have been selected according to this disclosure.

FIG. 19 shows a screenshot of an embodiment of a prompt presented over the screen of FIG. 15 where a percentage allocation for the index identifier and the fund identifier is input along with a name of an allocation model according to this disclosure.

FIG. 20 shows a screenshot of an embodiment of a prompt presented over the screen of FIG. 15 updated based on the percentage allocation according to this disclosure.

FIG. 21 shows a screenshot of an embodiment of a screen listing a set of underweight candidates and a set of overweight candidates presented side-by-side to each other according to this disclosure.

FIG. 22 shows a screenshot of an embodiment of a screen for selecting custom groups and negative preferences, one above another, in a new topical theme in a software wizard according to this disclosure.

FIG. 23 shows a screenshot of an embodiment of a screen listing a set of underweight candidates and a set of overweight candidates presented side-by-side to each other and updated based on selections made pursuant to FIG. 22 according to this disclosure.

FIG. 24 shows a screenshot of an embodiment of a screen for selecting themes, one above another, in a new topical theme in a software wizard according to this disclosure.

FIG. 25 shows a screenshot of an embodiment of a screen listing a set of underweight candidates and a set of overweight candidates presented side-by-side to each other and updated based on selections made pursuant to FIG. 24 according to this disclosure.

FIG. 26 shows a screenshot of an embodiment of a screen for entry of a set of parameters according to this disclosure.

FIG. 27 shows a screenshot of an embodiment of a screen listing a set of underweight candidates and a set of overweight candidates presented side-by-side to each other and updated based on selections made pursuant to FIG. 26 according to this disclosure.

FIG. 28 shows a screenshot of an embodiment of a screen with a toggle for application of preferences simultaneously shown according to this disclosure.

FIG. 29 shows a screenshot of an embodiment of a screen listing a set of underweight candidates and a set of overweight candidates presented side-by-side to each other and updated based on selections made pursuant to FIG. 28 according to this disclosure.

FIG. 30 shows a screenshot of an embodiment of a screen for a summary of elections according to this disclosure.

FIG. 31 shows a screenshot of an embodiment of a screen listing a set of underweight candidates and a set of overweight candidates presented side-by-side to each other and updated based on selections made pursuant to FIG. 30 according to this disclosure.

FIG. 32 shows a screenshot of an embodiment of a screen for naming a set of answers provided by a user according to this disclosure.

FIG. 33 shows a screenshot of an embodiment of a screen with a set of tiles updated with data pursuant to a set of answers provided by a user according to this disclosure.

FIG. 34 shows a diagram of a computing topology according to this disclosure.

### DETAILED DESCRIPTION

This disclosure solves various technological problems referenced above by enabling various improvements to functioning of computers (e.g., software wizards) where the second person is computationally enabled to enter the set of negative preferences to be included in the set of answers based on which the customized proposal report is generated by the application program, especially when the set of questions or the set of questions has the logical hierarchy or the informational interdependency. Such technology can be used in or adapted to be used for many fields of use. For example, in context of the service referenced above, there may be the first person who can computationally generate the customized proposal report based on the set of answers to the set of questions contained in the questionnaire, where the set of answers is provided by the second person, and where the set of answers includes the set of negative preferences, especially when the set of questions or the set of answers has the logical hierarchy or the informational interdependency. For example, there may be a web portal hosting a software wizard enabling the questionnaire by presenting (e.g., consecutively) the set of questions and receiving (e.g., consecutively) the set of answers as a step-by-step guide in a series of screens, each progressively narrowing or filtering a universe of available user choices, preferences, or options, whether positive, neutral, or negative, towards a final set of answers sufficient for generating the customized proposal report, by focusing on a specific task or configuration step, prompting the second person for necessary information or choices and providing explanations and guidance in at least some of such screens. For example, the software wizard may be a single software wizard or contain a set of software sub-wizards organized by a set of logical concepts (e.g., a set of topics, a set of content types). For example, the software wizard is internal to the application program, although the software wizard may be external to the application program. The first person may be a service provider representative, such as a vehicle mechanic, a medical doctor, a financial advisor, a wealth manager, an investment advisor, or other suitable fields of use that may employ the customized proposal report to the second person, who may be a potential client representative or an actual client representative. For example, the first person may be an investment advisor who may operate the computing terminal to generate the customized proposal report based on the set of answers to the set of questions contained in the questionnaire, where the set of answers is provided, guided, or informed by the second person's investment preferences, and where the set of answers includes the set of negative preferences, especially when the set of questions or the set of answers has the logical hierarchy or the informational interdependency, which may be enabled by the software wizard presenting the set of questions and receiving the set of answers, as explained above. Therefore, the first person, as the investment advisor (e.g., institutional, investment, retail), may deploy the customized proposal report to disclose (e.g., by availing for download, emailing) an investment strategy for the second person, as the potential client.

This disclosure is now described more fully with reference to screenshots, in which some embodiments of this disclosure are shown. This disclosure may, however, be embodied in many different forms and should not be construed as necessarily being limited to only embodiments disclosed herein. Rather, these embodiments are provided so that this disclosure is thorough and complete, and fully conveys various concepts of this disclosure to skilled artisans.

Note that various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Similarly, as used herein, various singular forms “a,” “an” and “the” are intended to include various plural forms (e.g., two, three, four) as well, unless context clearly indicates otherwise. For example, a term “a” or “an” shall mean “one or more,” even though a phrase “one or more” is also used herein.

Moreover, terms “comprises,” “includes” or “comprising,” “including” when used in this specification, specify a presence of stated features, integers, steps, operations, elements, or components, but do not preclude a presence or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

Additionally, although terms first, second, and others can be used herein to describe various elements, components, regions, layers, or sections, these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section without departing from this disclosure.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

Moreover, features or functionality described with respect to certain example embodiments may be combined and sub-combined in or with various other example embodiments. Also, different aspects or elements of example embodiments, as disclosed herein, may be combined and sub-combined in a similar manner as well. Further, some example embodiments, whether individually or collectively, may be components of a larger system, wherein other procedures may take precedence over or otherwise modify their application. Additionally, a number of steps may be required before, after, or concurrently with example embodiments, as disclosed herein. Note that any or all methods or processes, at least as disclosed herein, can be at least partially performed via at least one entity or actor in any manner.

Hereby, all issued patents, published patent applications, and non-patent publications (including hyperlinked articles, web pages, and websites) that are mentioned in this disclosure are herein incorporated by reference in their entirety for all purposes, to same extent as if each individual issued patent, published patent application, or non-patent publication were specifically and individually indicated to be incorporated by reference. If any disclosures are incorporated herein by reference and such disclosures conflict in part or in whole with this disclosure, then to the extent of conflict, or broader disclosure, or broader definition of terms, this disclosure controls. If such disclosures conflict in part or in whole with one another, then to the extent of conflict, then the later-dated disclosure controls.

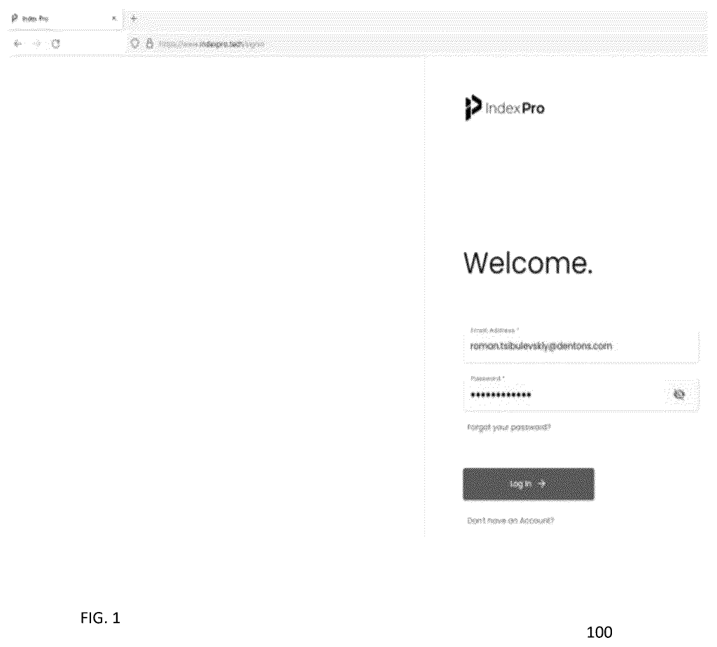

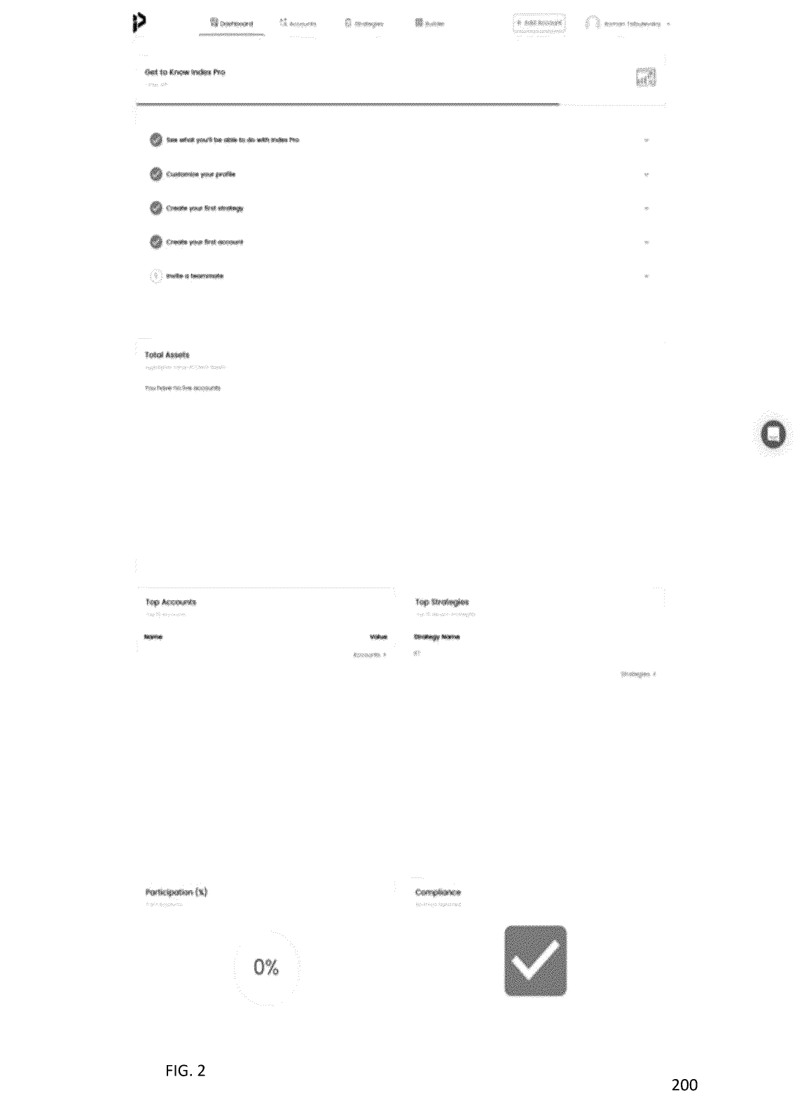

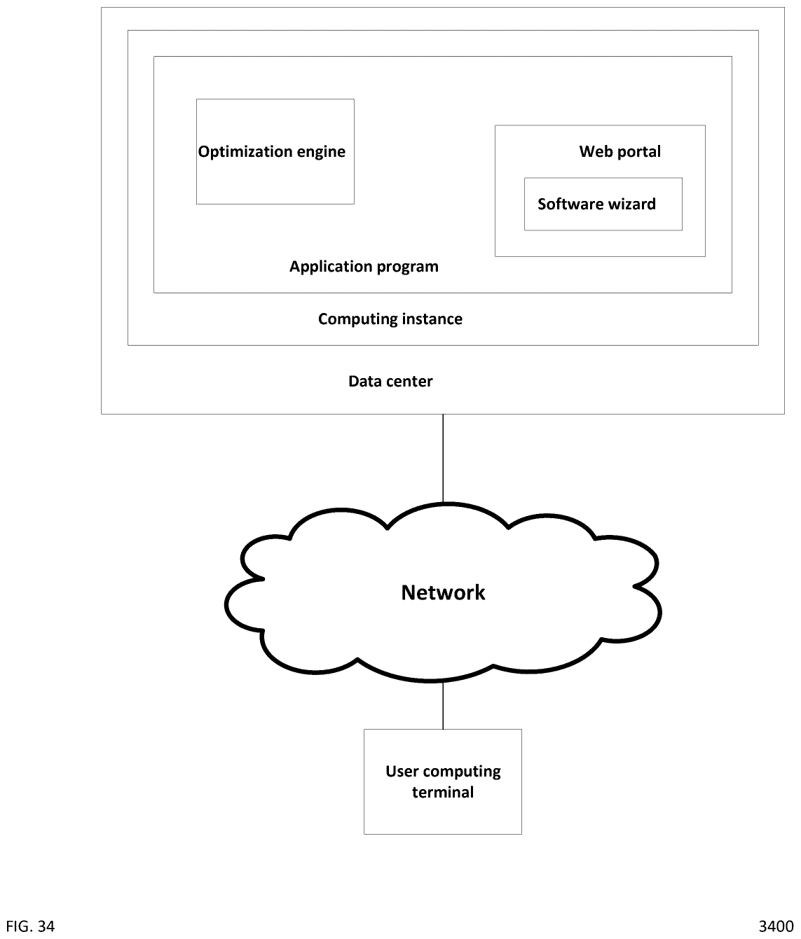

As referenced above, FIG. 1 shows the screenshot of the embodiment of the screen 100 programmed for securely accessing the web portal by entering the email address and the password each for a profile according to this disclosure. Likewise, FIG. 2 shows the screenshot of the embodiment of the user interface of the web portal being securely accessed after entering the email address and the password each for the profile according to this disclosure. FIG. 34 shows the diagram of the embodiment of the computing topology 3400 according to this disclosure In particular, the customized proposal report in the data file is generated by the web portal (e.g., vertical type) hosting the software wizard having the user interface, which may be a graphical user interface (GUI) 200, as enabled by a computing instance having a hardware architecture, a software architecture running on the hardware architecture, and an algorithm performed by the software architecture running on the hardware architecture, as disclosed herein. The hardware architecture includes a set of physical machines (e.g., servers, routers, switches) working in concert, to enable the software architecture, including the web portal hosting the software wizard, as disclosed herein. The hardware architecture may be hosted in a single data center (e.g., to increase responsiveness) or distributively hosted among a set of data centers (e.g., to increase redundancy), to enable the web portal hosting the software wizard, as disclosed herein. The software architecture includes an application program (e.g., a CRM application program) distributively running on the set of physical machines, and hosting the web portal hosting the software wizard, as disclosed herein. The algorithm includes a set of steps (or actions) performed by the application program distributively running on the set of physical machines, to provide the web portal hosting the software wizard, as disclosed herein.

The web portal may be embodied as a specialized website that brings together information and services from diverse data sources into a unified and personalized user interface. For example, the web portal may be a personal web portal. The web portal is accessed via the computing terminal. The computing terminal may be embodied as a desktop computer, a laptop computer, a tablet computer, a smartphone, a wearable computer (e.g., an eyewear computer), or another suitable computing form factor. The computing terminal hosts a web browser application program, which is operated by the second person, such as a user (e.g., a service receiver representative) operating the computing terminal, to navigate the GUI 200 to generate the customized proposal report (e.g., a file, an HTML file, a PDF file, a productivity document file, a word processor file, a presentation file, a spreadsheet file) for access (e.g., read, download) by the browser application program, as disclosed herein. As such, the web portal is accessed by the browser application program over a network (e.g., a wide area network (WAN), a local area network (LAN)). The web browser application may be technologically advantageous for (i) non-technical personnel due to widespread knowledge of browser usage and (ii) technical personnel due to lack of dedicated application programs to maintain. Note that the browser application program is not required and another software form factor can be used. For example, this software form factor may be a task-dedicated application program dedicated to perform a task, whether the task is to generate the customized proposal report or another suitable task. The task-dedicated application program may be technologically advantageous for (i) non-technical personnel for simplicity of use and (ii) simplicity of maintenance. For example, the task-dedicated application program may be embodied as a mobile app where the computing terminal may be a tablet computer, a smartphone, or another suitable computing form factor running the mobile app.

The GUI 200 can be embodied as a single menu or a set of menus. For example, the GUI 200 can be a single webpage enabling the software wizard to generate the customized proposal report or a set of webpages collectively enabling the software wizard to generate the customized proposal report. The software wizard may be a single screen or distributed among a set of screens, which may be consecutive.

The web portal is operative based on a profile hierarchy hosted by the application program distributively running on the set of physical machines. The profile hierarchy includes a set of group profiles (e.g., data objects, data structures, arrays, vectors), a set of first profiles (e.g., data objects, data structures, arrays, vectors), a set of second profiles (e.g., data objects, data structures, arrays, vectors), and a set of preference listings (e.g., data objects, data structures, arrays, vectors). Each group profile in the set of group profiles one-to-many corresponds to the set of first profiles and is hierarchically and logically higher than the set of first profiles. Each first profile in the set of first profiles one-to-many corresponds to the set of second profiles and is hierarchically and logically higher than the set of second profiles. Each second profile in the set of second profiles one-to-many corresponds to the set of preference listings and is hierarchically and logically higher than the set of preference listings. For example, when implemented in an investment advisory function, the set of group profiles may represent a set of firm accounts (e.g., firm A, firm B, firm n), the set of first profiles may represent a set of user accounts (e.g., investment advisor A, investment advisor B, investment advisor n), the set of second profiles may represent a set of customer accounts (e.g., customer A, customer B, customer n), and the set of preference listings may represent a set of investment strategies (e.g., investment strategy A, investment strategy B, investment strategy n). For example, in some use cases, a single second profile from the set of second profiles can have a single set of preference listings from the set of preference listings, i.e., a one-to-one correspondence, although this configuration is not required. As such, a group profile (e.g., firm A) may have many first profiles (e.g., investment advisor A and investment advisor B), where each first profile may have many second profiles (e.g., customer A and customer B) and each second profile may have a single preference listing (e.g., investment strategy A) or many preference listings (e.g., investment strategy A and investment strategy B). Note that the web portal may be enabled to have superuser profiles or administrator profiles to set up or administer the profile hierarchy, as disclosed herein.

The user operates the browser application hosted on the computing terminal to access the web portal over the network to create a first profile for the set of first profiles in a group profile from the set of group profiles via the GUI 200 and then login into the web portal via the GUI 200, as shown in FIG. 1. Note that the web portal may host the screen 100 of FIG. 1 or the screen 100 of FIG. 1 may be separate and distinct from the web portal. Once the user, who is now the first profile, is logged into the web portal, the user is further presented with the GUI 200, as shown in FIG. 2.

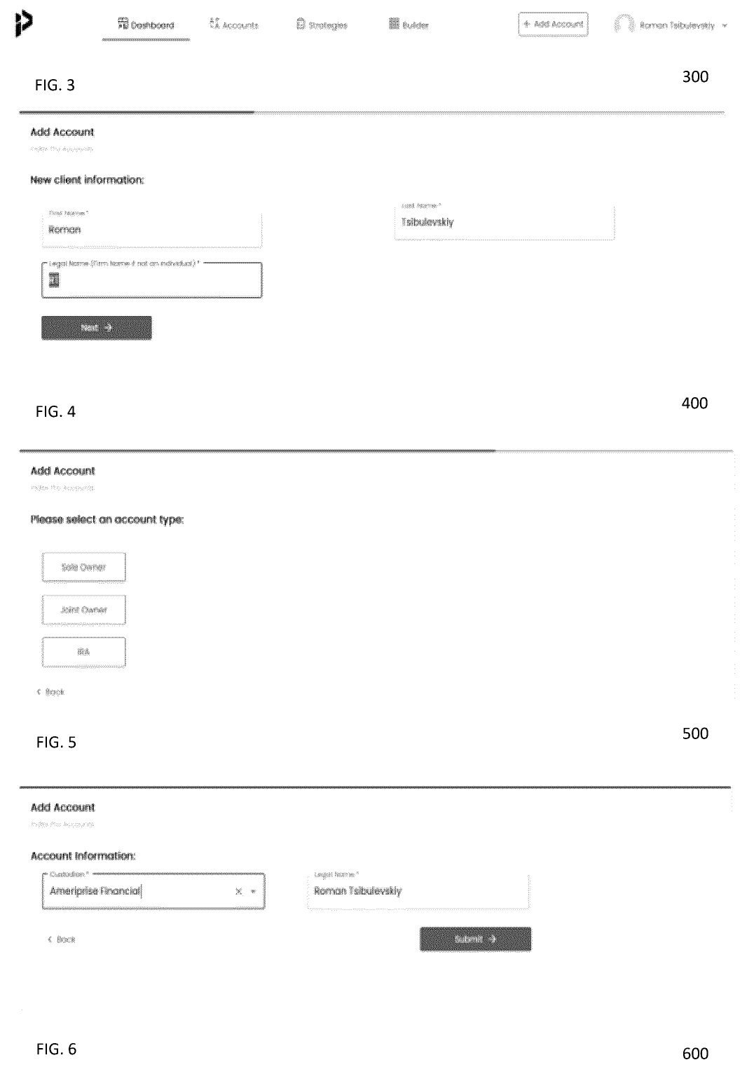

As referenced above, FIG. 3 shows the screenshot of the embodiment of the header 300 of the user interface 200 of the web portal according to this disclosure. In particular, the first profile is present in the set of first profiles. As such, the user navigates the GUI 200 to access the header 300 to activate (e.g., by clicking) a visual element (e.g., a button having an add account text label depicted thereon) to begin creating a second profile (e.g., customer A, customer B) for the set of second profiles to be associated with the first profile, as explained above. Note that the header 300 of the GUI 200 includes a general dashboard heading (underlined or otherwise made visually distinct when selected), an accounts (second profile) heading (may be underlined or otherwise made visually distinct when selected), a strategies (preference listing) heading (may be underlined or otherwise made visually distinct when selected), and a builder (e.g., a software wizard) heading (may be underlined or otherwise made visually distinct when selected), where each of such headings may present its own screen, dashboard, or menu, which be separate and distinct from other such screens, dashboards, or menus.

As referenced above, FIG. 4 shows the screenshot of the embodiment of the menu 400 of the user interface to enter identifying profile information according to this disclosure. FIG. 5 shows the screenshot of the embodiment of the menu 500 of the user interface to select the account type according to this disclosure. FIG. 6 shows the screenshot of the embodiment of the menu 600 of the user interface to input account information according to this disclosure. As such, in response to activating the visual element (e.g., a button having an add account text label depicted thereon) shown in the menu 300, as explained above, the GUI presents the menu 400 (e.g., add account), as shown in FIG. 4, under the accounts heading, as shown in FIG. 3. The menu 400 is presented such that the first profile from the set of first profiles is enabled to input a set of identifiers for the second profile, as shown in FIG. 4, when creating the second profile for the set of second profiles. This configuration enables the web portal to generate the customized proposal report specifically for the second profile, although this configuration is not required. For example, when implemented in an investment advisory function, the menu 400 may prompt the user for input (e.g., by typing, selecting, speaking) of the set of identifiers including a first identifier (e.g., a first name associated with the second profile), a second identifier (e.g., a last name associated with the second profile), and a third identifier (e.g., a legal name associated with the second profile). Likewise, the menu 500 may prompt the user for input (e.g., by typing, selecting, speaking) of a type identifier (e.g., a sole account, a joint account, an individual retirement account associated with the second profile). Similarly, the menu 600 may prompt the user for input (e.g., by typing, selecting, speaking) of a fourth identifier (e.g., a custodian associated with the second profile), and other suitable identifiers, as shown below, although anonymous data entry is possible. Although the menu 500 follows the menu 400 and the menu 600 follows the menu 500, this configuration is not required and the menus 400, 500, and 600 may be presented in a different order or as a single menu.

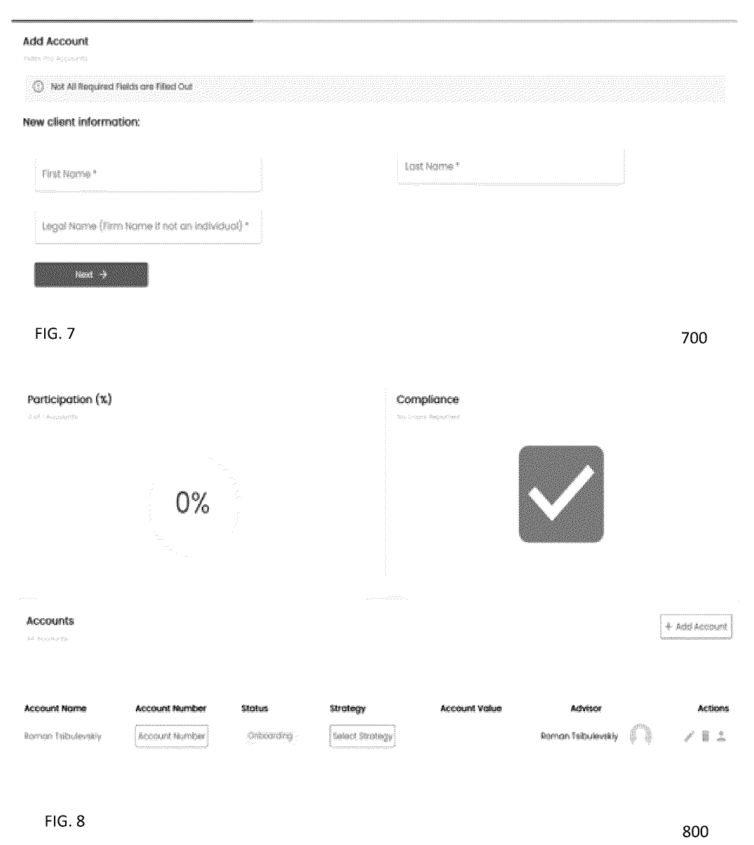

As referenced above, FIG. 7 shows the screenshot of the embodiment of the prompt or warning 700 for the menu of the user interface to enter identifying profile information according to this disclosure. As such, if some identifiers in the set of identifiers, as shown in FIG. 7, are not input by the user, then the menu may present the prompt or warning 700 regarding what is not input. Note that the prompt or warning 700 is optional and the customized proposal report may be created without the prompt or warning 700 shown in FIG. 7.

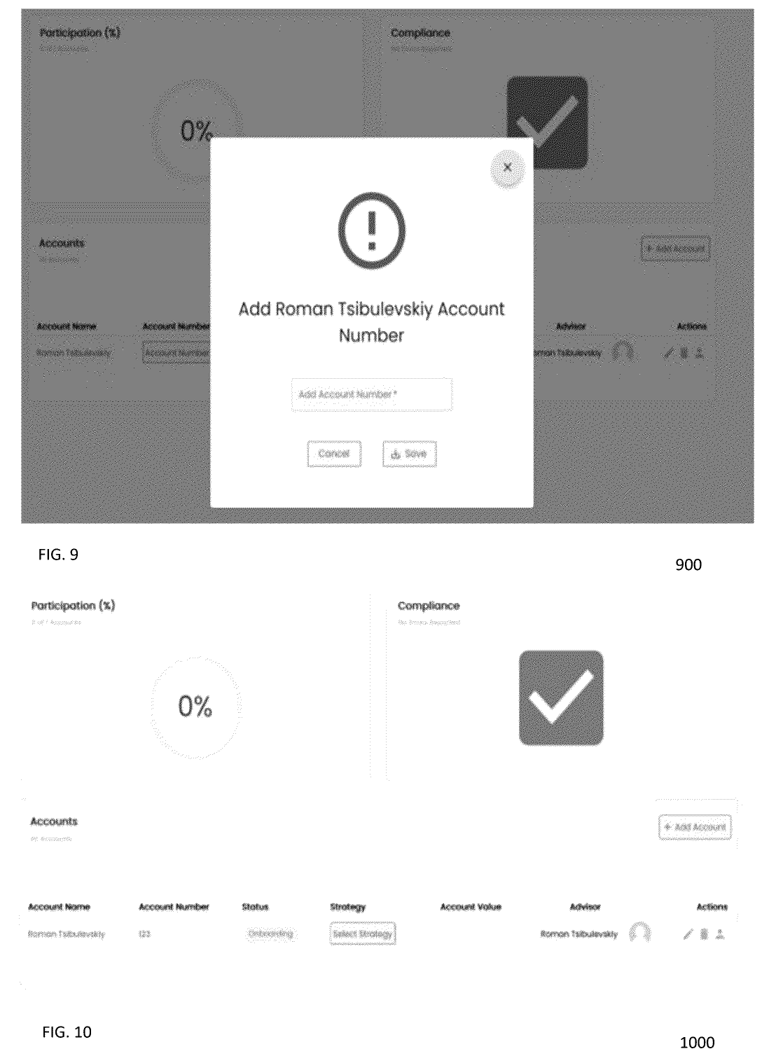

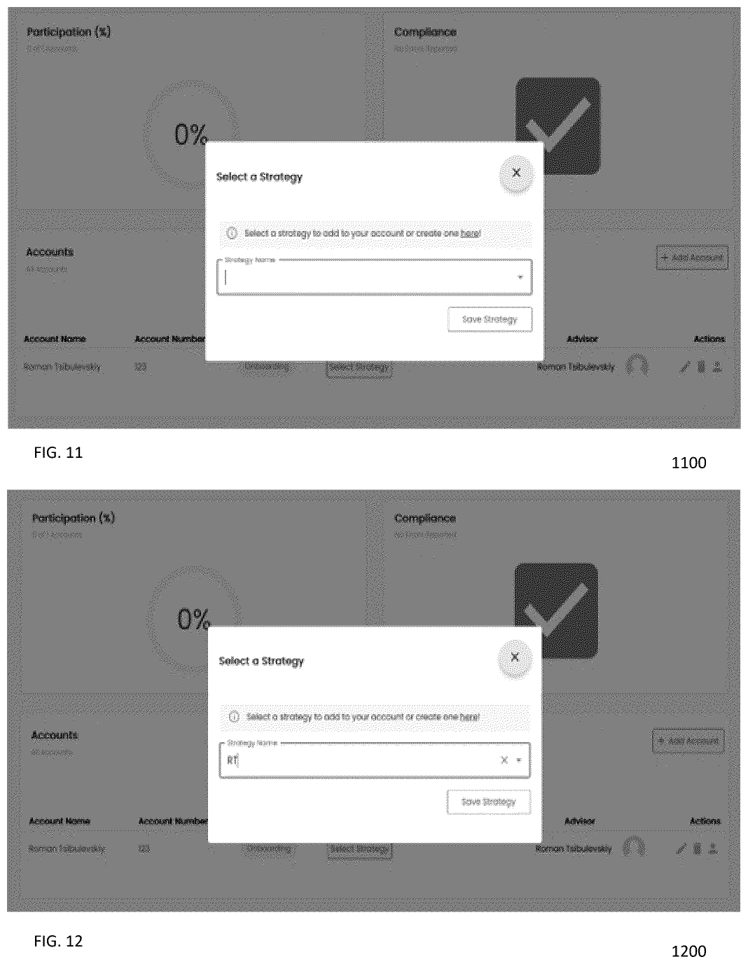

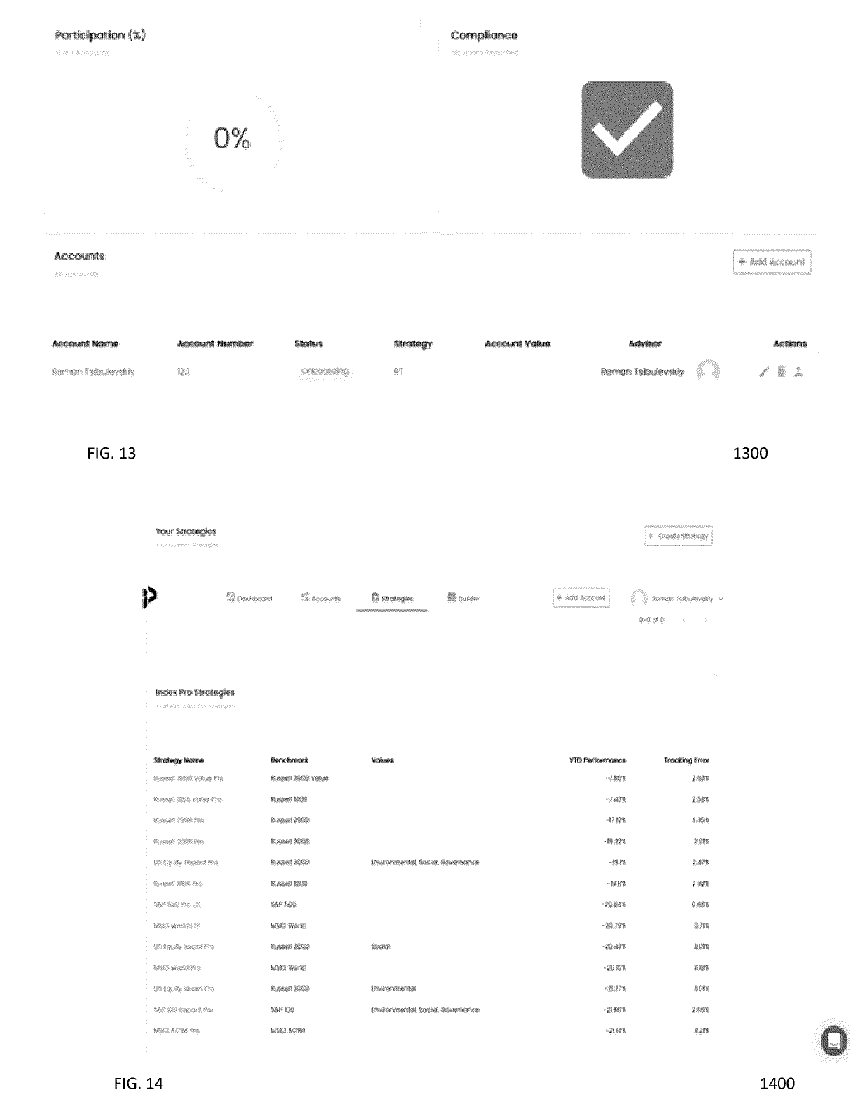

As referenced above, FIG. 8 shows the screenshot of the embodiment of the screen 800 depicting the status dashboard according to this disclosure, FIG. 9 shows the screenshot of the embodiment of the prompt 900 to add the account number presented over the screen depicting the status dashboard according to this disclosure, FIG. 10 shows the screenshot of the embodiment of the screen 1000 depicting the status dashboard with the account number added according to this disclosure, FIG. 11 shows the screenshot of the embodiment of the prompt 1100 to input the strategy identifier presented over the screen depicting the status dashboard according to this disclosure, FIG. 12 shows the screenshot of the embodiment of the prompt 1200 with the strategy identifier input as presented over the screen depicting the status dashboard according to this disclosure, and FIG. 13 shows the screenshot of the embodiment of the screen 1300 depicting the status dashboard where the account number and the strategy identifier each as input are presented according to this disclosure. As such, once the set of identifiers is input, then the GUI 200 presents the user with the dashboard, as shown in FIGS. 8-13. As shown in FIGS. 9-10, the dashboard enables the user to input the account number to be associated with the second profile that has been created, as explained above, and, as shown in FIGS. 11-12, to input (create or edit) the preference listing (e.g., an investment strategy). The account number is enabled to be input when a button (or another suitable visual element) that is correspondingly labeled is activated (e.g., by clicking), as shown in FIG. 8. The preference listing is enabled to be input when a button (or another suitable visual element) that is correspondingly labeled is activated (e.g., by clicking), as shown in FIGS. 10-12, and the user can select the second profile to correspond to the preference listing, as shown in FIGS. 8-13.

As referenced above, FIG. 14 shows the screenshot of the embodiment of the screen 1400 depicting the list of hyperlinks named with the list of strategy identifiers presented in the tabular format according to this disclosure. Resultantly, the screen 1400 depicts a summary of strategy identifiers, along with a respective set of parameters, presented in the tabular format, under the strategies heading, as referenced above. As such, regardless of whether the second profile from the set of second profiles exists or corresponds to the first profile from the set of first profiles, the user can operate the GUI 200 to select the builder heading, as referenced above, to present the software wizard having a set of menus to individually create the set of preference listings (e.g., the set of strategies), one-by-one, as summarized in the tabular format shown in FIG. 14. For each preference listing in the set of preference listing, the set of menus may be separate and distinct from each other based on a set of logical concepts (e.g., topics) to enable the user to operate the GUI 200 in a user-friendly manner to minimize confusion among the set of logical concepts, although the menu may be a single menu (e.g., a single webpage), which may be vertically or horizontally scrollable. The set of menus presents the set of questions (e.g., a virtual questionnaire which may be reflexive) having the logical hierarchy and the informational interdependency, as further disclosed herein. As such, the customized proposal report can be generated based on such data collected from the software wizard, as disclosed herein. For example, when implemented in an investment advisory function, the set of group profiles may represent a set of firm accounts (e.g., firm A, firm B, firm n), the set of first profiles may represent a set of user accounts (e.g., investment advisor A, investment advisor B, investment advisor n), the set of second profiles may represent a set of customer accounts (e.g., customer A, customer B, customer n), and the set of preference listings may represent a set of investment strategies (e.g., investment strategy A, investment strategy B, investment strategy n). For example, in some use cases, a single preference listing from the set of preference listings can be common to, shared with, or utilized by multiple second profiles from the set of second profiles, i.e., one-to-many correspondence, although this configuration is not required. As such, a group profile (e.g., firm A) may have many first profiles (e.g., investment advisor A and investment advisor B), where each first profile may have many second profiles (e.g., customer A and customer B) and each second profile may have many or one preference listing at any given time (e.g., investment strategy A). Therefore, the user can select the builder heading, as shown in FIG. 14, to present the software wizard having the set of menus to create or modify any preference listing of the set of preference listings, as shown in FIG. 14, whether the set of second profiles exists or corresponds to the set of first profiles or not. For example, this may enable a demo feature or a testing feature for generating the customized proposal report.

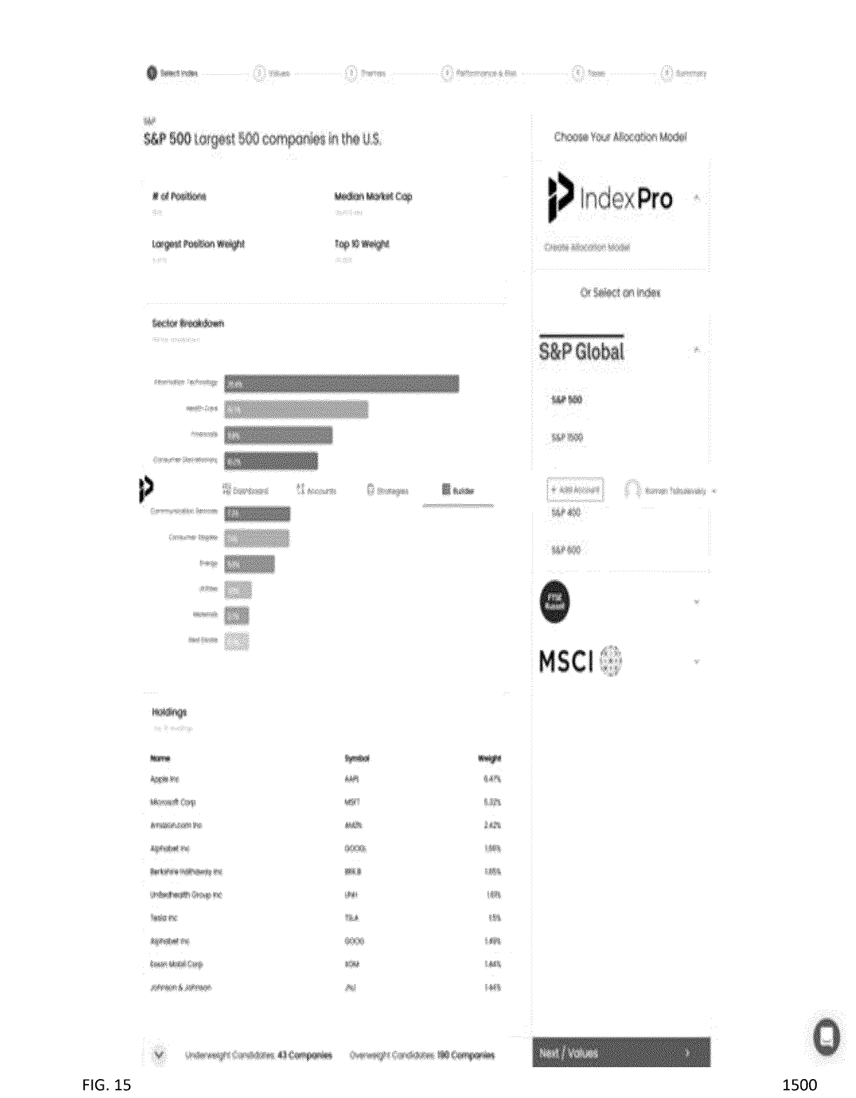

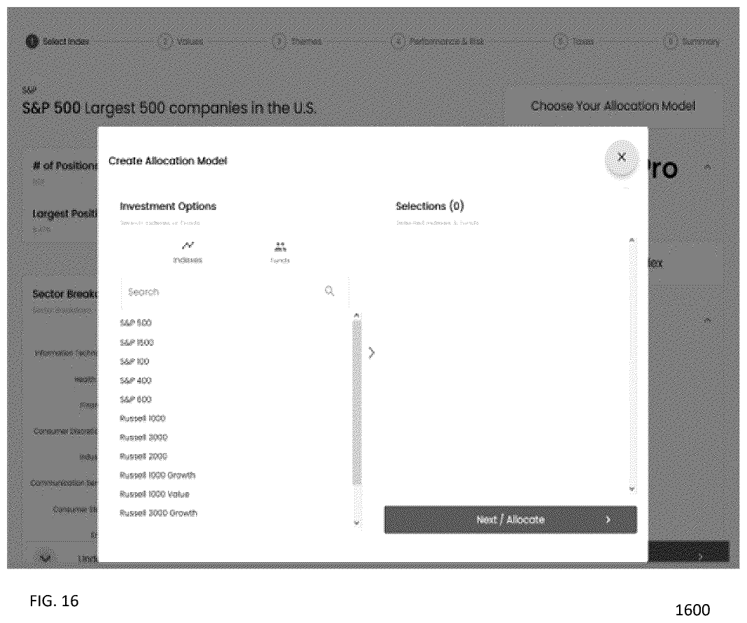

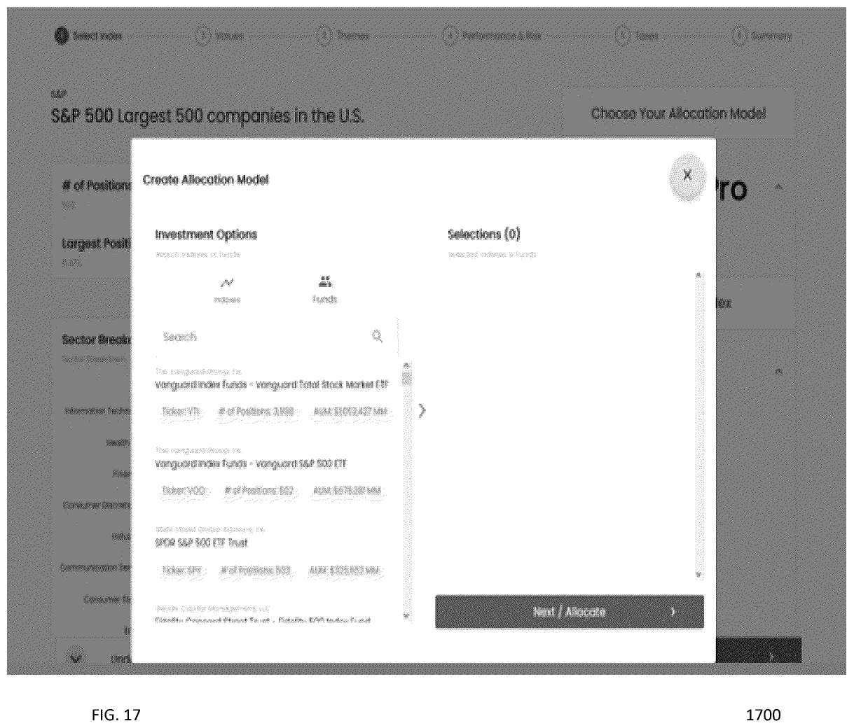

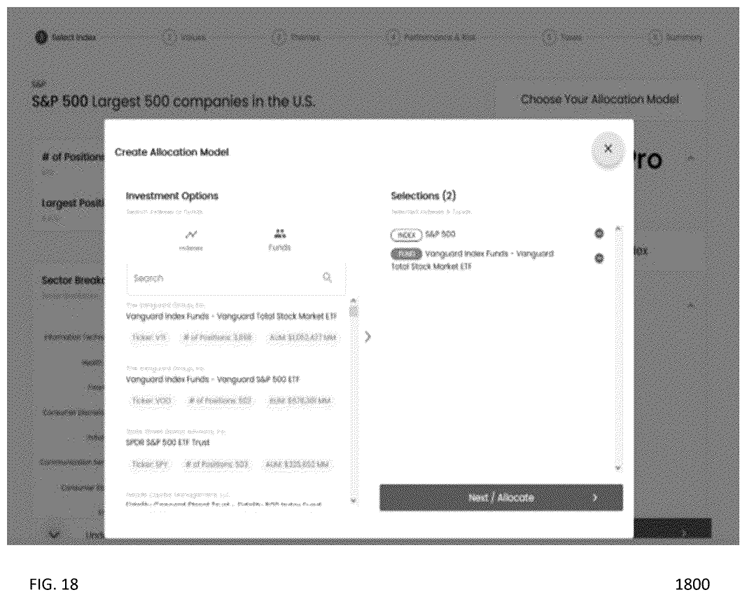

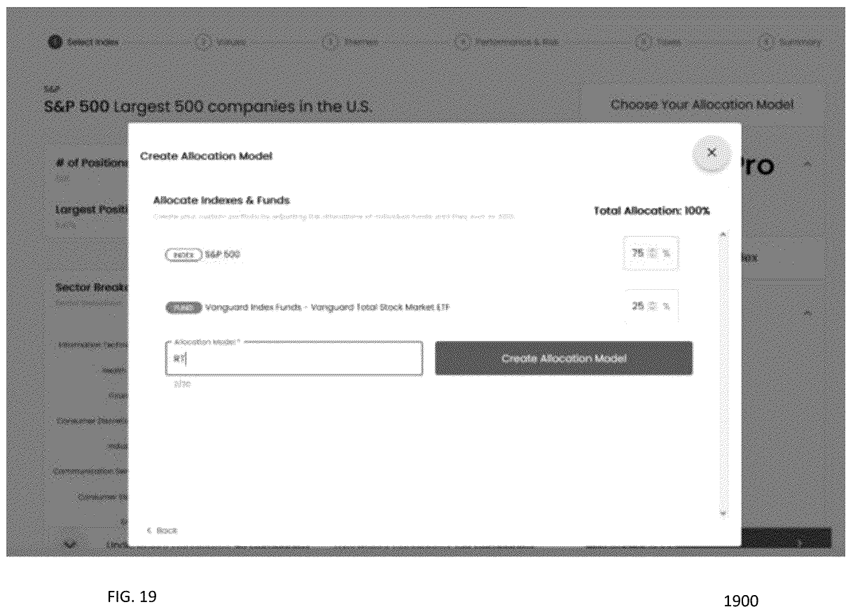

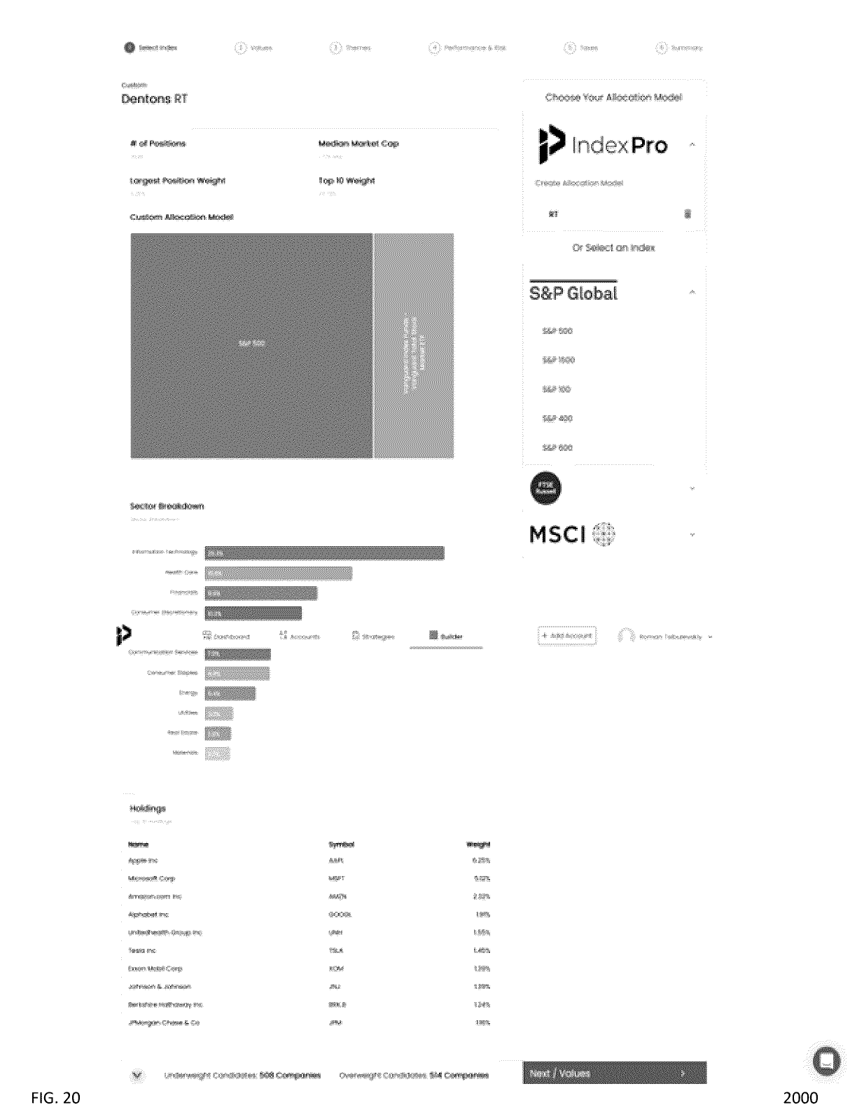

As referenced above, FIG. 15 shows the screenshot of the embodiment of the screen 1500 depicting the first step of the software wizard according to this disclosure, FIG. 16 shows the screenshot of the embodiment of the prompt 1600 presented over the screen of FIG. 15 to create the allocation model from the set of index identifiers according to this disclosure, FIG. 17 shows the screenshot of the embodiment of the prompt 1700 presented over the screen of FIG. 15 to create the allocation model from the set of fund identifiers according to this disclosure, FIG. 18 shows the screenshot of the embodiment of the prompt 1800 presented over the screen of FIG. 15 where the index identifier and the fund identifier have been selected according to this disclosure, FIG. 19 shows the screenshot of the embodiment of the prompt 1900 presented over the screen of FIG. 15 where the percentage allocation for the index identifier and the fund identifier is input along with the name of the allocation model according to this disclosure, and FIG. 20 shows the screenshot of the embodiment of the prompt presented over the screen of FIG. 15 updated based on the percentage allocation according to this disclosure. Therefore, the user operates the GUI 200 to select the builder heading to present the software wizard having the set of menus to create or modify any preference listing of the set of preference listings, as shown in FIG. 14, such that the GUI 200 initiates the software wizard to present a set of input elements (e.g., a hyperlink, a dropdown menu, a button, a dial, a slider, a checkbox) and a set of output elements (e.g., a diagram, a table, a pane, a menu, a prompt, a window), which may be empty, populated or set according to a set of default rules (e.g., a set of default templates), as in FIG. 15. The user can operate the GUI 200 to modify the set of input elements to deviate from the set of default rules, as shown in FIGS. 16-20. The set of output elements may correspondingly update in real-time (e.g., dynamically, responsively) when the set of input elements is modified to deviate from the set of default rules, as shown in FIGS. 16-20.

As shown in FIG. 15, the user operates the GUI 200 to select an input element (e.g., a hyperlink) to (a) present a sub-wizard to create an allocation model (e.g., referenced by an IndexPro label), as shown in FIGS. 16-20, or (b) select an index identifier (e.g., referenced by an S&P 500 label, an S&P 1500 label) from a set of index identifiers via a set of dropdown menus (or other suitable input elements) hierarchically corresponding to a set of manager identifiers (e.g., referenced by an S&P Global label, an MSCI label), as shown in FIG. 15. Each of the allocation model, as created, or the index identifier or the set of index identifiers, as selected, is associated with a respective set of ticker symbols (e.g., alphanumeric strings) or sets of ticker symbols (e.g., alphanumeric strings). The allocation model, as created, or the index identifier or the set of index identifiers, as selected, may enable a superset of ticker symbols or sets of ticker symbols based on which the software wizard is enabled to generate the customized proposal report, as disclosed herein.

FIGS. 16-18 show the prompt 1600 having two panes (left—options) and right—selections), where one pane (left—options) is programmed to be toggled by clicking a desired label (e.g., indexes text/graphic or funds text/graphic) shown therein in order to switch between two different searchable input modalities, with two different data listings (e.g., data sources), which enables an input (e.g., selection, typing) of either index identifiers or funds identifiers, but not both (although this configuration may vary in other embodiments). Whatever index identifiers or fund identifiers that are selected in one pane (left) appear as selections in another pane (right), where selections are counted adjacent to a selection label (e.g., (0, 2), as shown in FIGS. 17 and 18, and where those selections are selectively user removable from that pane (right) as needed by clicking a graphic (e.g., red) adjacent to each such selection. Note that if a field of use is other than an investment advisory, then the set of ticker symbols or the sets of ticker symbols may employ a set of symbols or strings or sets of symbols or strings that are suitable or adapted for the field of use. As shown in FIG. 17, each ticker symbol in the respective set of ticker symbols or sets of ticker symbols shown in one pane (left) under one searchable input modality (e.g., funds text/graphic) may have its own tag or set of tags (e.g., ovals with corresponding labels) shown, with data for such tags being sourced from data sources external to the web portal, as disclosed herein. For example, these tags may include a label and a ticker symbol, a label and a first value identifier (e.g., number of positions) for an amount, and an label and a second value identifier (e.g., assets under management). These tags are used in the set of menus of the software wizard, as described below, to enable further filtering of the superset of ticker symbols or the sets of ticker symbols on which the software wizard is enabled to generate the customized proposal report, as disclosed herein. Note that tags do not carry over to pane (right), although this configuration is not required and such carryover is possible. Each screen in the prompt 1600 is navigable by an input element (e.g., a button) with a next label to reach the prompt 1900 where allocation values are user entered (e.g., typed, selected), a name is entered (e.g., typed) to be proposed for that respective allocation model, and an input element (e.g., a button) is presented to save those allocation values and the name as the allocation model. As such, the prompt 2000 is then shown in which various tiles (or panes) are correspondingly updated based on data entered pursuant to FIGS. 15-20. One form of such updating is color-coding a shape (e.g., a rectangle) based on allocations (e.g., blue and orange), while showing various statistical data (e.g., number of holding positions, statistical weights) corresponding to such allocations. Another form of such updating is various bar diagrams (e.g., horizontal) per group identifiers (e.g., sectors) for selected allocations. Therefore, these types of data entry enable selection of data for generating the customized proposal reports, as disclosed herein.

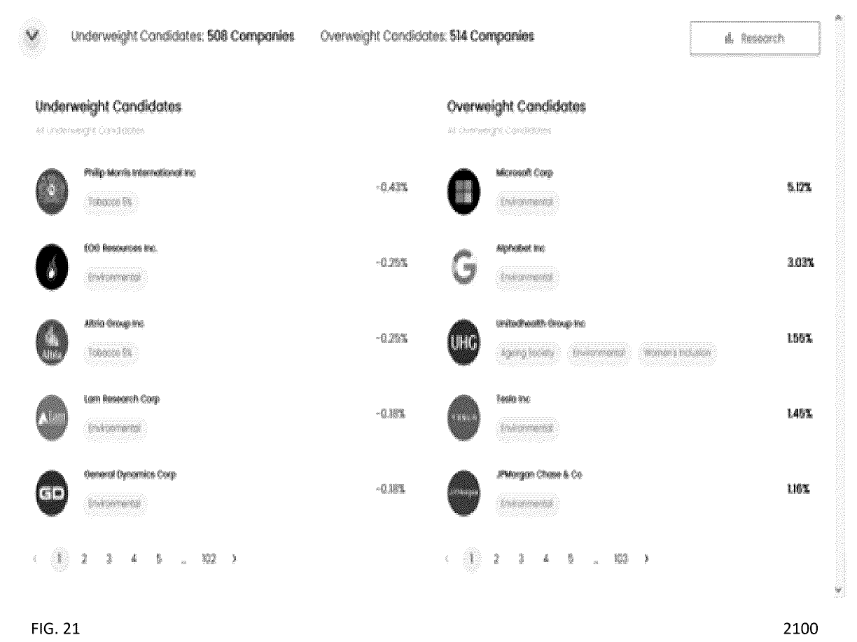

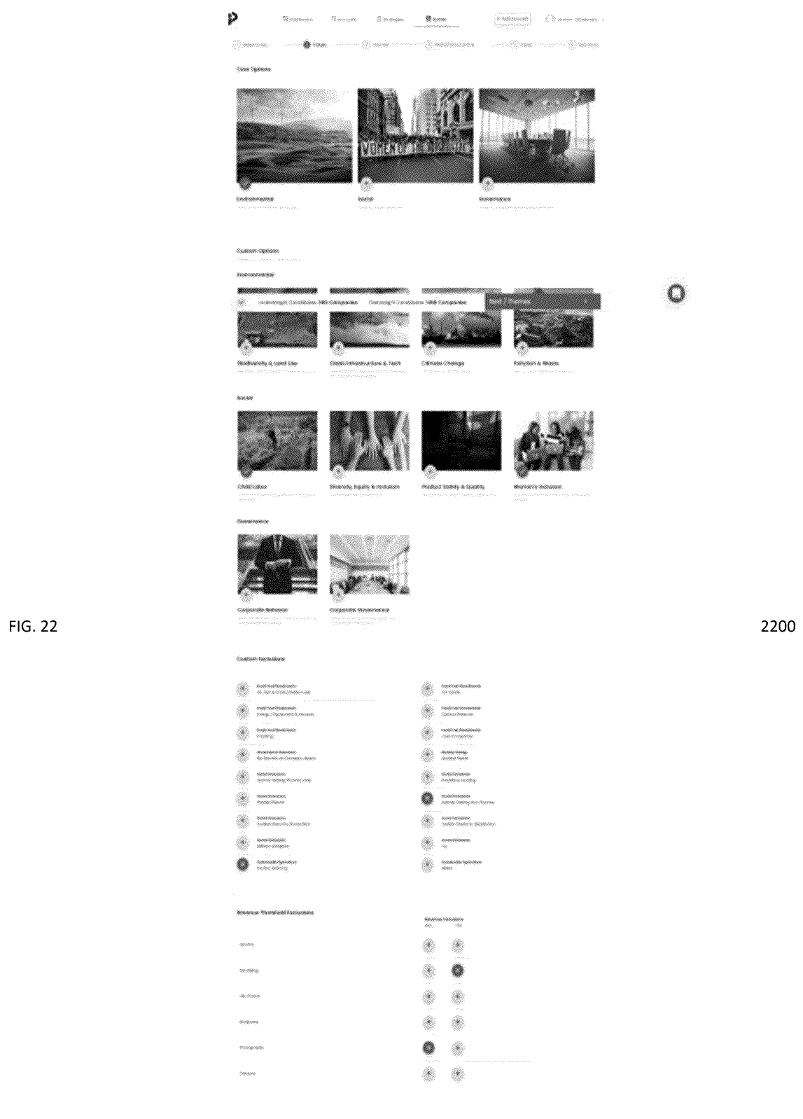

FIG. 21 shows the screenshot of the embodiment of the screen 2100 listing the set of underweight candidates and the set of overweight candidates presented side-by-side to each other according to this disclosure. The screen 2100 is activated by clicking the down arrows shown (dropdown menu) in the screen 2000 (bottom). The screen 2100 and the screen 2000 can be different screens or a single screen. For example, as shown in FIG. 20, upon clicking the down arrows in the screen 2000, the screen 2000 is vertically expanded (for vertical scrolling) to show the screen 2100, where the screen 2100 lists the set of underweight candidates and the set of overweight candidates in a tabular format, row-by-row, respectively forming cells. Each of such cells corresponds to one candidate and respectively shows a graphic (e.g., a thumbnail image) for that one candidate, a name identifier for that one candidate associated with the graphic, a category tag for that one candidate associated with the graphic, and a percentage value for statistical underweight or overweight category for that one candidate. Therefore, the GUI 200 has the dropdown menu presenting the screen 2100 having a tabular diagram having a set of names (e.g., Philip Morris International Inc.) corresponding to a set of ticker symbols (e.g., PM), a set of type tags (e.g., tobacco), and a set of weight values (e.g., underweight −0.43%), which may be dynamically updated in real-time by filtering of the superset of ticker symbols or the sets of ticker symbols on which the software wizard is enabled to generate the customized proposal report, as disclosed herein. For example, a ticker symbol (e.g., an alphanumeric string, F, GM, NKE, MSFT) from the set of ticker symbols may be presented with a corresponding image (e.g., a thumbnail image). The set of names is associated with the allocation model that has been created or the index identifier or the set of index identifiers that has been selected. As shown in FIG. 21, the set of names is sorted by the set of weight values decreasing in value (but can be increasing in value) together with the set of ticker symbols and the set of type tags. The set of names can be dynamically adjusted in real-time based on the allocation index that the user created or the index identifier or the set of index identifiers that the user selects based on the set of weight values. Note that the screen 2100 has a summary header having a first label (e.g., underweight) and a first dynamically updated amount (e.g., 508) for identifiers presented in a first visually distinct manner (e.g., bolding) and a second label (e.g., overweight) having a second dynamically updated amount (e.g., 514) for identifiers presented in a second visually distinct manner (e.g., bolding). The first label along with the first dynamically presented amount is horizontally colinearly presented with the second label along with the second dynamically presented amount.

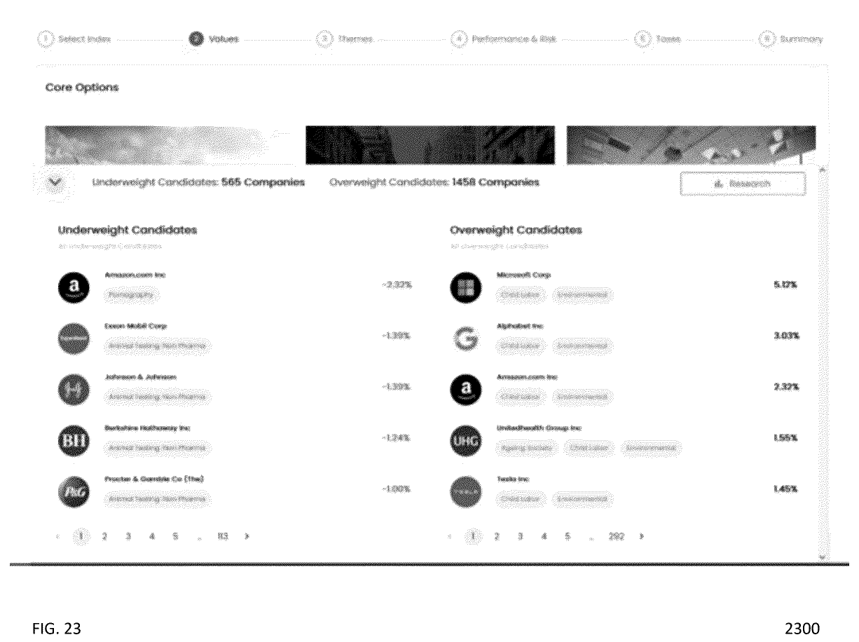

FIG. 22 shows the screenshot of the embodiment of the screen 2200 for selecting custom groups and negative preferences, one above another, in the new topical theme (e.g., values) in the software wizard according to this disclosure. Note that the past topical theme (e.g., select index) and the new topical theme are visibly tracked (e.g., by visual distinction, bolding, underlining) as a timeline or an event line (e.g., horizontal line) on top of FIG. 22, below the headings (e.g., dashboard, accounts, strategies, builder), which enables quick overview as where in the software wizard the user current is. FIG. 23 shows the screenshot of the embodiment of the screen 2300 listing the set of underweight candidates and the set of overweight candidates presented side-by-side to each other and updated based on the selections made pursuant to FIG. 22 according to this disclosure. As such, once the user operates the GUI 200 to create the allocation model via the sub-wizard or select the index identifier or the set of index identifiers, the user operates the GUI 200 to select a next input element (e.g., a Next/Values button) so that the GUI 200 moves onto a next menu (e.g., values heading) of the software wizard, as shown in FIG. 22. For example, the next menu may include (1) a set of tiles positioned to form a grid, each tile containing a corresponding image (e.g., a thumbnail image) along with a corresponding identifier and a user input element (e.g., a hyperlink, a button, a hyperlink button), (2) a listing of a set of group exclusion identifiers and a corresponding user input element (e.g., a hyperlink, a button, a hyperlink button), and (3) a listing of a set of value exclusion identifiers (e.g., by any value or greater or less than a preset value) and a corresponding user input element (e.g., a hyperlink, a button, a hyperlink button), each for interaction by the user, as further described below. Note that the menu may be a single menu (e.g., vertically scrollable) or a set of menus that may be separate and distinct from each other based on a set of logical concepts to enable the user to operate the GUI in a user-friendly manner, to minimize conceptual confusion.

As shown in FIG. 22, this menu (e.g., values heading) of the software wizard allows the user to select (i) a tile (or tiles) for a group identifier (e.g., Environmental, Social, Governance) of a score calculated by a formula from a set of sub-scores each having a different statistical weight for the formula, or (ii) a set of tiles for a set of sub-group identifiers for the set of sub-scores (e.g., clean infrastructure, child labor, corporate behavior) to allow for a more finer focus for the group identifier, or (iii) a set of category exclusion identifiers (e.g., fossil fuel divestments), which function as the set of negative preferences, or (iv) a set of threshold exclusion identifiers (e.g., alcohol, gambling) for any threshold value or a percentage thereof function for a group or sub-group of identifiers, which function as the set of negative preferences. For example, a group identifier, a sub-group identifier, a category exclusion identifier, or a threshold exclusion identifier may be presented with a corresponding image (e.g., a thumbnail image). Note that the dropdown menu presenting the diagram, as discussed above, is dynamically updated in real-time based on (i) the tile (or tiles) for the group identifier or (ii) the set of tiles for the set of sub-group identifiers while considering the negative preferences, i.e., excluding (iii) the set of category exclusion identifiers or (iv) the set of threshold exclusion identifiers, where the set of negative preferences being input in this menu by filtering of the superset of ticker symbols or the sets of ticker symbols on which the software wizard is enabled to generate the customized proposal report, as disclosed herein. Correspondingly, as shown in FIG. 23, the screen 2300 is updated in real-time to dynamically provide an up-to-date listing the set of underweight candidates and the set of overweight candidates presented side-by-side to each other and updated based on the selections made pursuant to the screen 2200 (e.g., 508/514 of FIGS. 21 to 565/1458 of FIG. 23). Once the user operates the GUI 200 to input the set of negative preferences, the user operates the GUI 200 to select a next input element (e.g., a Next/Themes button) so that the GUI 200 moves onto a next topic menu (e.g., values heading) of the software wizard, as described below. Note that the next input element at this menu is different in textual content from the next input element at prior menu, as the software wizard guides the user among the set of menus, to minimize user confusion.

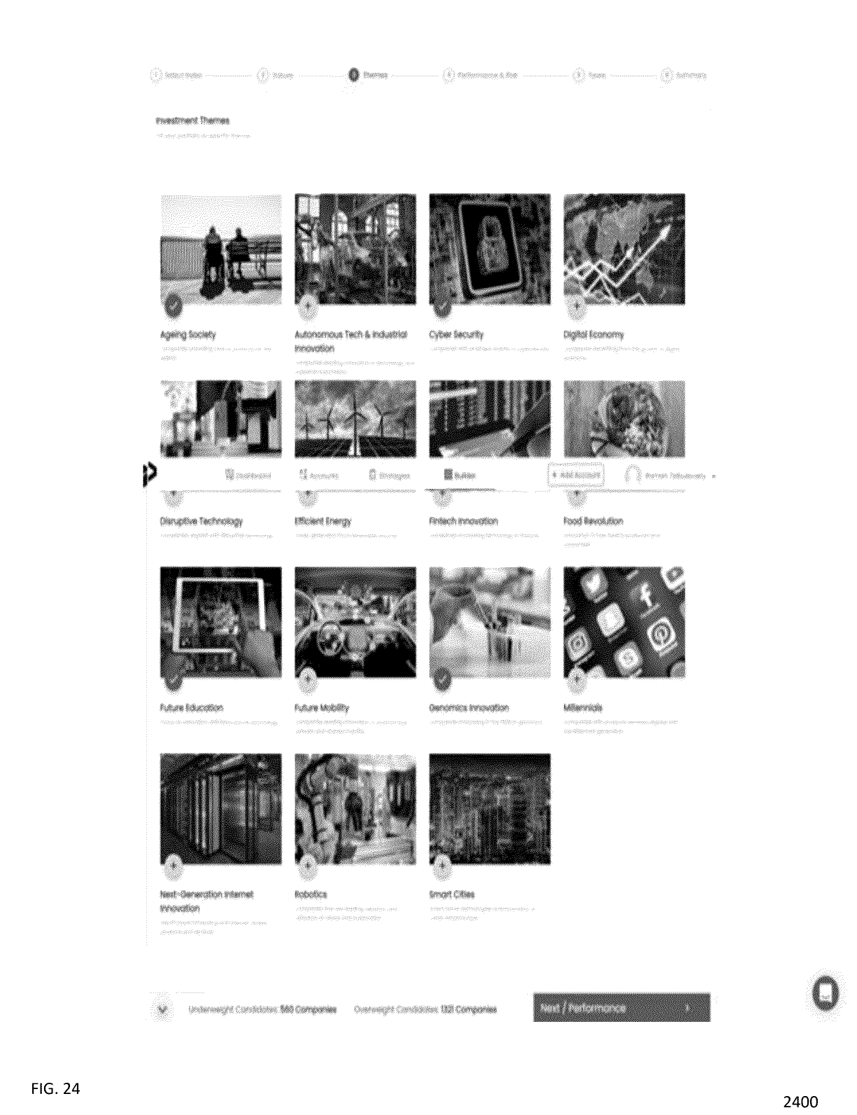

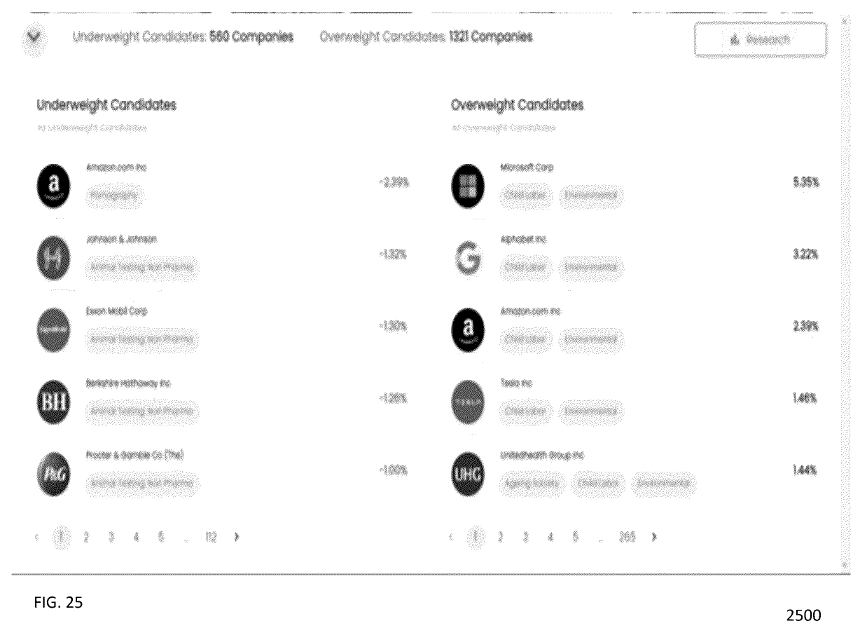

FIG. 24 shows the screenshot of the embodiment of the screen 2400 for selecting themes, one above another, in the new topical theme (e.g., themes) in the software wizard according to this disclosure. FIG. 25 shows the screenshot of the embodiment of the screen 2500 listing the set of underweight candidates and the set of overweight candidates presented side-by-side to each other and updated based on selections made pursuant to FIG. 24 according to this disclosure. The screen 2400 shows a menu (e.g., labeled as a Themes heading) of the software wizard allows the user to select a category threshold identifier (e.g., robotics, millennials), which may be associated with a corresponding image (e.g., a thumbnail image), further specifying a data organization of previous menus. For example, this menu may include a set of tiles positioned to form a grid, each tile containing a corresponding image (e.g., a thumbnail image) along with a corresponding identifier and a user input element (e.g., a hyperlink, a button, a hyperlink button) for interaction by the user, as further described below. The screen 2500 shows the dropdown menu presenting the diagram, as discussed above, that is again dynamically updated in real-time (e.g., 508/514 of FIGS. 21 to 560/1321 of FIG. 25) based on the category threshold identifier being input in this menu by filtering of the superset of ticker symbols or the sets of ticker symbols on which the software wizard is enabled to generate the customized proposal report, as disclosed herein. Once the user operates the GUI 200 to input the category threshold identifier, the user operates the GUI 200 to select a next input element (e.g., a Next/Performance button) so that the GUI 200 moves onto a next menu (e.g., labeled as a Performance & Risk heading) of the software wizard, as shown below. Note that the next input element at this menu is different in textual content from the next input element at prior menu, as the software wizard guides the user among the set of menus, while being presented adjacent to the dropdown menu of FIG. 23 or persisting on in that area while the screen 2300 is scrolled (e.g., vertically).

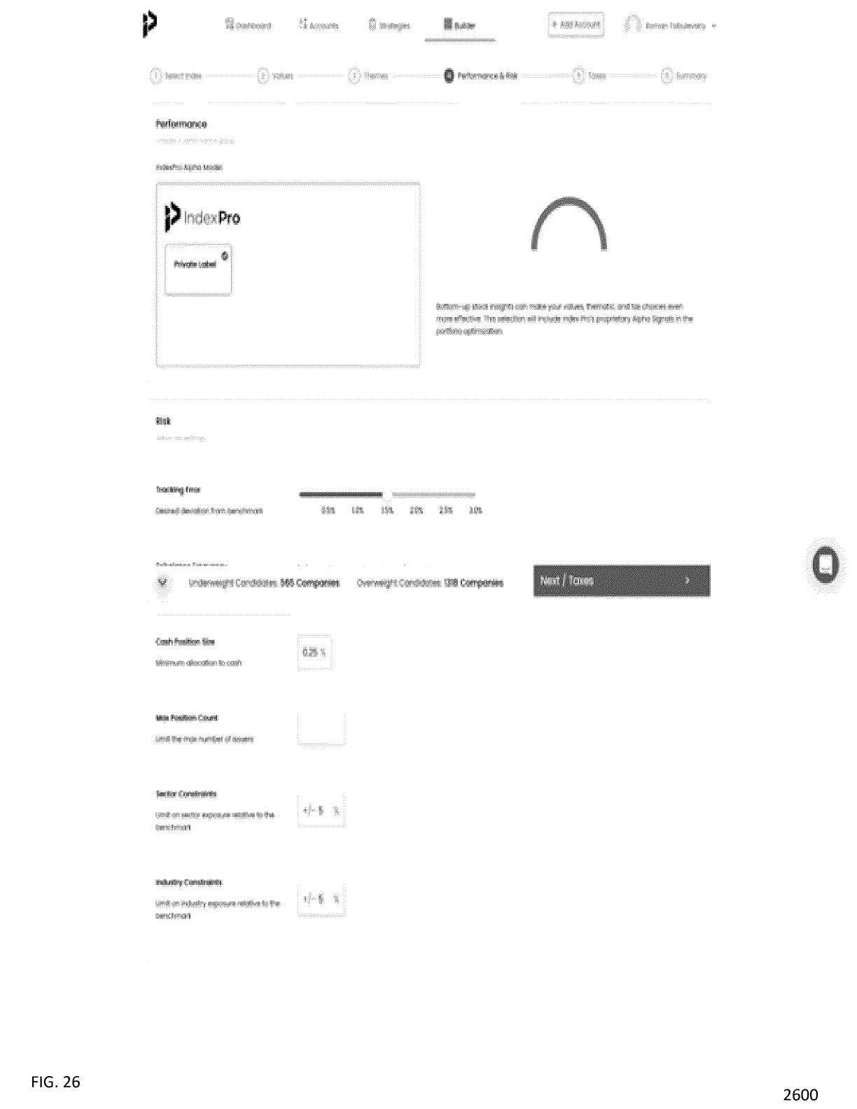

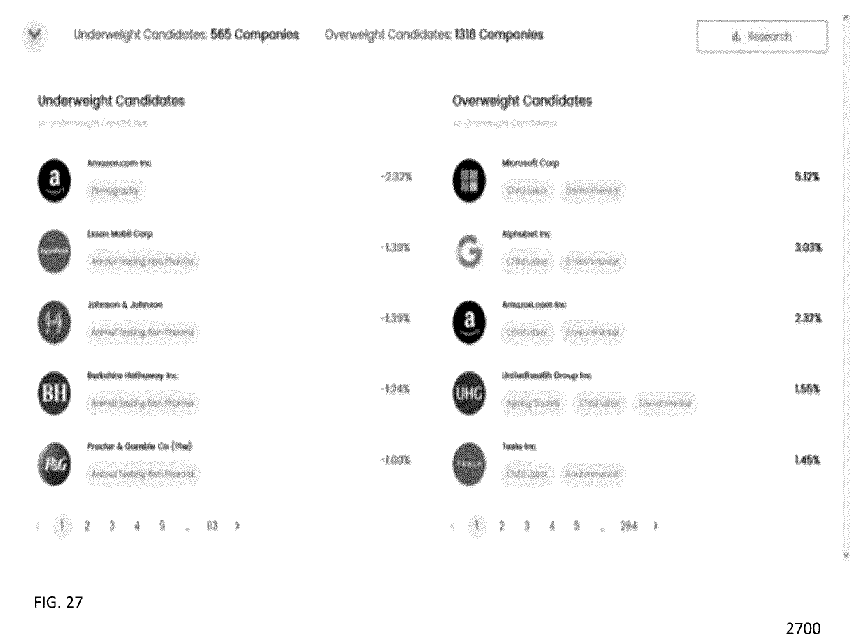

FIG. 26 shows the screenshot of the embodiment of the screen 2600 for entry of the set of parameters according to this disclosure. FIG. 27 shows the screenshot of the embodiment of the screen 2700 listing the set of underweight candidates and the set of overweight candidates presented side-by-side to each other and updated based on selections made pursuant to FIG. 26 according to this disclosure. The screen 2600 shows a menu (e.g., labeled as a Performance & Risk heading) of the software wizard that allows the user to input (e.g., by typing or selecting) (i) an optimization model identifier by operating a button, a labeled (e.g., private) button, a labeled button, a gradual level selector, a slider, a knob, a dial, a textbox, a checkbox, a dropdown menu, or another suitable user input element, which may be presented with a corresponding image (e.g., a thumbnail image), or (ii) an identifier for a maximum desired deviation from a benchmark via a button, a labeled button, a gradual level selector, a slider, a knob, a dial, a textbox, a checkbox, a dropdown menu, or another suitable user input element, which may be presented with a corresponding image (e.g., a thumbnail image), or (iii) a rebalancing frequency identifier (e.g., daily, monthly) via a button, a labeled button, a gradual level selector, a slider, a knob, a dial, a textbox, a checkbox, a dropdown menu, or another suitable user input element, which may be presented with a corresponding image (e.g., a thumbnail image), or (iv) a minimum value identifier (e.g., a resource or cash position size) via a button, a labeled button, a gradual level selector, a slider, a knob, a dial, a textbox, a checkbox, a dropdown menu, or another suitable user input element, which may be presented with a corresponding image (e.g., a thumbnail image), or (v) a maximum count (e.g., a maximum position count) via a button, a labeled button, a gradual level selector, a slider, a knob, a dial, a textbox, a dropdown menu, or another suitable user input element, which may be presented with a corresponding image (e.g., a thumbnail image), or (vi) a first constraint (e.g., a sector grouping) identifier relative to the benchmark (e.g., a sector constraint via a button, a labeled button, a gradual level selector, a slider, a knob, a dial, a textbox, a checkbox, a dropdown menu, or another suitable user input element, which may be presented with a corresponding image (e.g., a thumbnail image), or (vii) a second constraint (e.g., an industry grouping) identifier relative to the benchmark (e.g., industry constraint) via a button, a labeled button, a gradual level selector, a slider, a knob, a dial, a textbox, a checkbox, a dropdown menu, or another suitable user input element, which may be presented with a corresponding image (e.g., a thumbnail image), or any other user input elements that further specify the data organization of previous menus. The screen 2700 shows the dropdown menu presenting the diagram, as discussed above, is again dynamically updated in real-time (e.g., 560/1321 of FIGS. 25 to 565/1318 of FIG. 27) based on inputs in this menu by filtering of the superset of ticker symbols or the sets of ticker symbols on which the software wizard is enabled to generate the customized proposal report, as disclosed herein. Once the user operates the GUI 200 to input data the user operates the GUI 200 to select a next input element (e.g., a Next/Taxes button) so that the GUI 200 moves onto a next menu (e.g., labeled as a Taxes heading) of the software wizard, as shown below. Note that the next input element at this menu is different in textual content from the next input element at prior menu, as the software wizard guides the user among the set of menus.

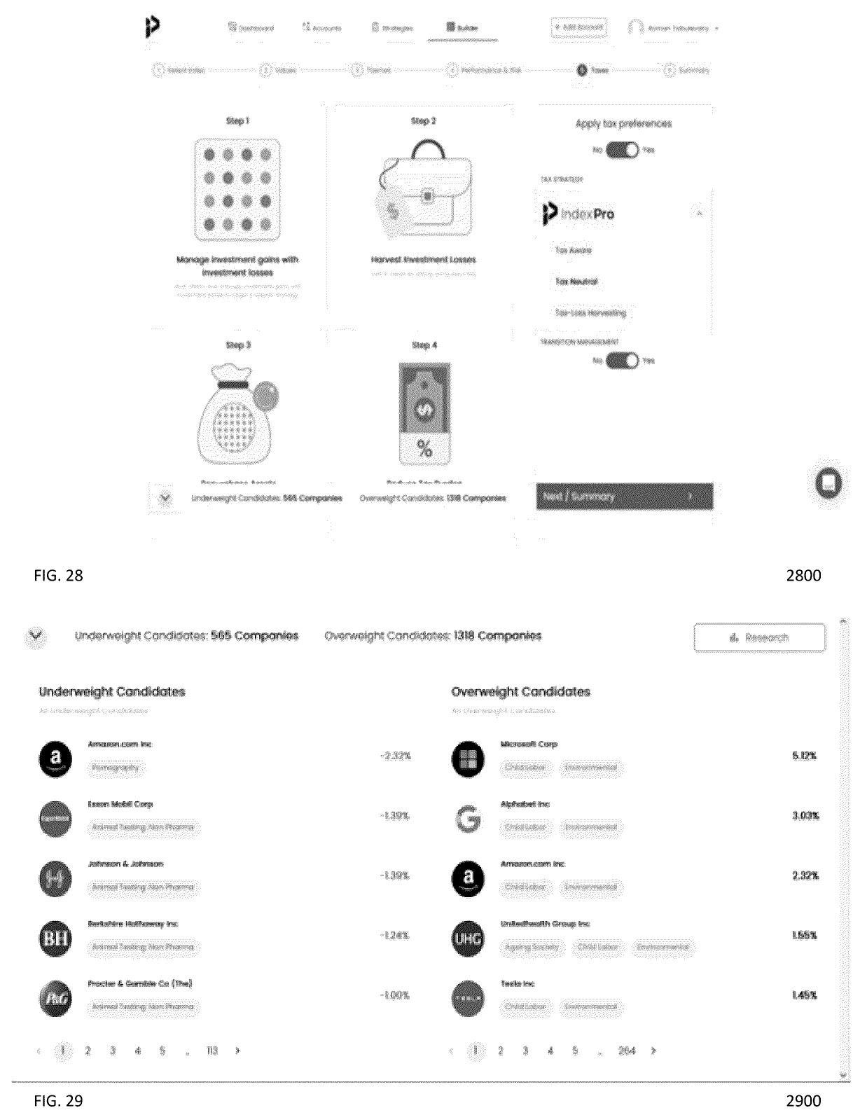

FIG. 28 shows the screenshot of the embodiment of the screen 2800 with the toggle for application of preferences simultaneously shown according to this disclosure. FIG. 29 shows the screenshot of the embodiment of the screen 2900 listing the set of underweight candidates and the set of overweight candidates presented side-by-side to each other and updated based on selections made pursuant to FIG. 28 according to this disclosure. The screen 2800 shows a menu (e.g., labeled as a Taxes heading) of the software wizard that allows the user to select various identifiers, any of which may be presented with a corresponding image (e.g., a thumbnail image), in a dropdown menu, for an optimization algorithm (e.g., tax aware, neutral, loss harvesting) or any other user input elements that further specify the data organization of previous menus. The dropdown menu extends between an toggle element and a lower toggle element, operative independent of each other, to provide further parameters for collection of data by the software wizard. Note that the dropdown menu presenting the diagram, as discussed above, is again dynamically updated in real-time (e.g., 565/1318 of FIGS. 27 to 565/1318 of FIG. 28) based on inputs in this menu. Once the user operates the GUI 200 to input data the user operates the GUI 200 to select a next input element (e.g., a Next/Summary button) so that the GUI 200 moves onto a next menu (e.g., labeled as a Summary heading) of the software wizard. Note that the next input element at this menu is different in textual content from the next input element at prior menu, as the software wizard guides the user among the set of menus.

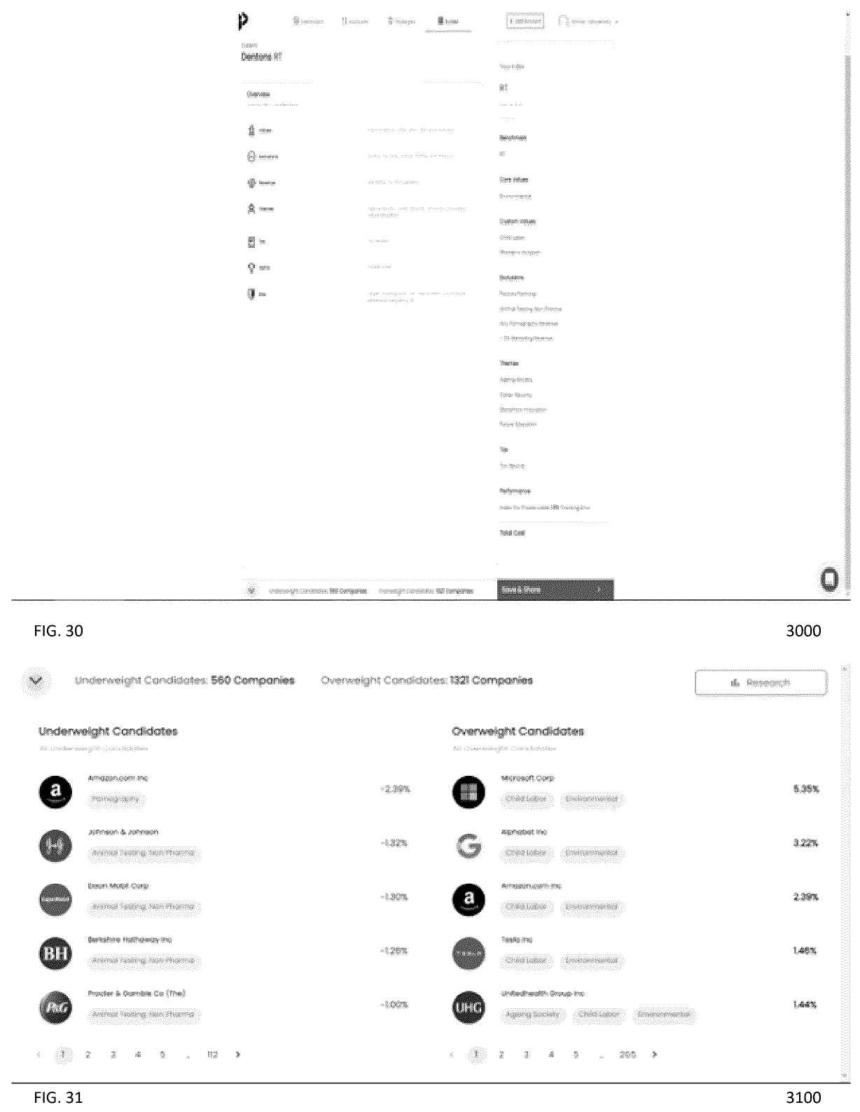

FIG. 30 shows the screenshot of the embodiment of the screen 3000 for the summary of elections according to this disclosure. FIG. 31 shows the screenshot of the embodiment of the screen 3100 listing a set of underweight candidates and a set of overweight candidates presented side-by-side to each other and updated based on selections made pursuant to FIG. 30 according to this disclosure.

The screen 3000 has a menu (e.g., labeled as a Summary heading) of the software wizard, where the menu allows the user to observe a summary of whatever the user input in the set of menus that were presented prior to this menu. If the user identifies certain mistakes, then the user may go back to prior menus either sequentially or jump to a specific prior menu to make changes according to which the software wizard would update other menus and the summary. Note that the dropdown menu presenting the diagram, as discussed above, is again dynamically updated in real-time (e.g., 565/1318 of FIGS. 28 to 560/1321 of FIG. 31) based on inputs in this menu by filtering of the superset of ticker symbols or the sets of ticker symbols on which the software wizard is enabled to generate the customized proposal report, as disclosed herein. Once the user operates the GUI 200 to input data the user operates the GUI to select a next input element (e.g., a Next/Save button) so that the GUI moves onto a next menu (e.g., name your strategy) of the software wizard, as shown below, to save this set of preference listings. Note that the next input element at this menu is different in textual content from the next input element at prior menu, as the software wizard guides the user among the set of menus.

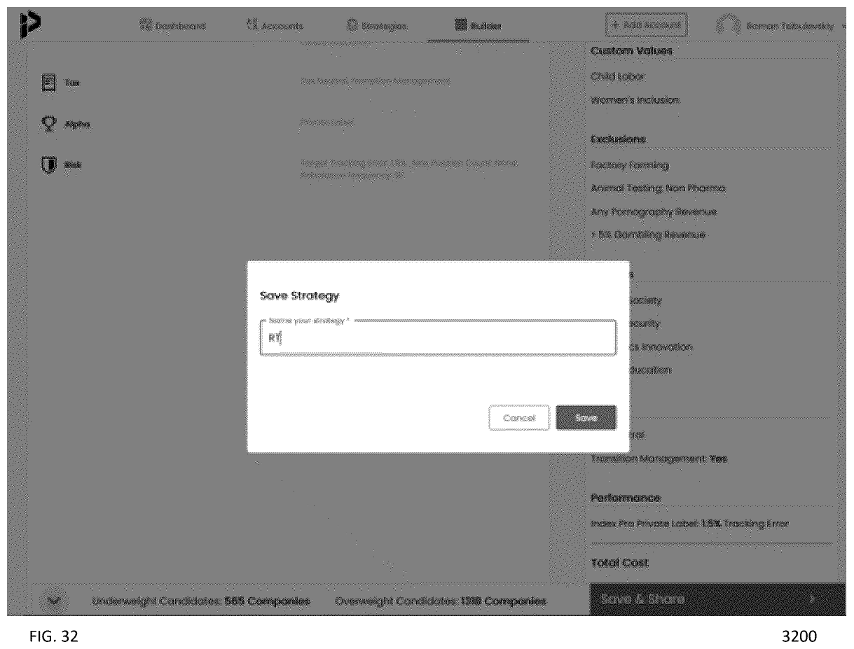

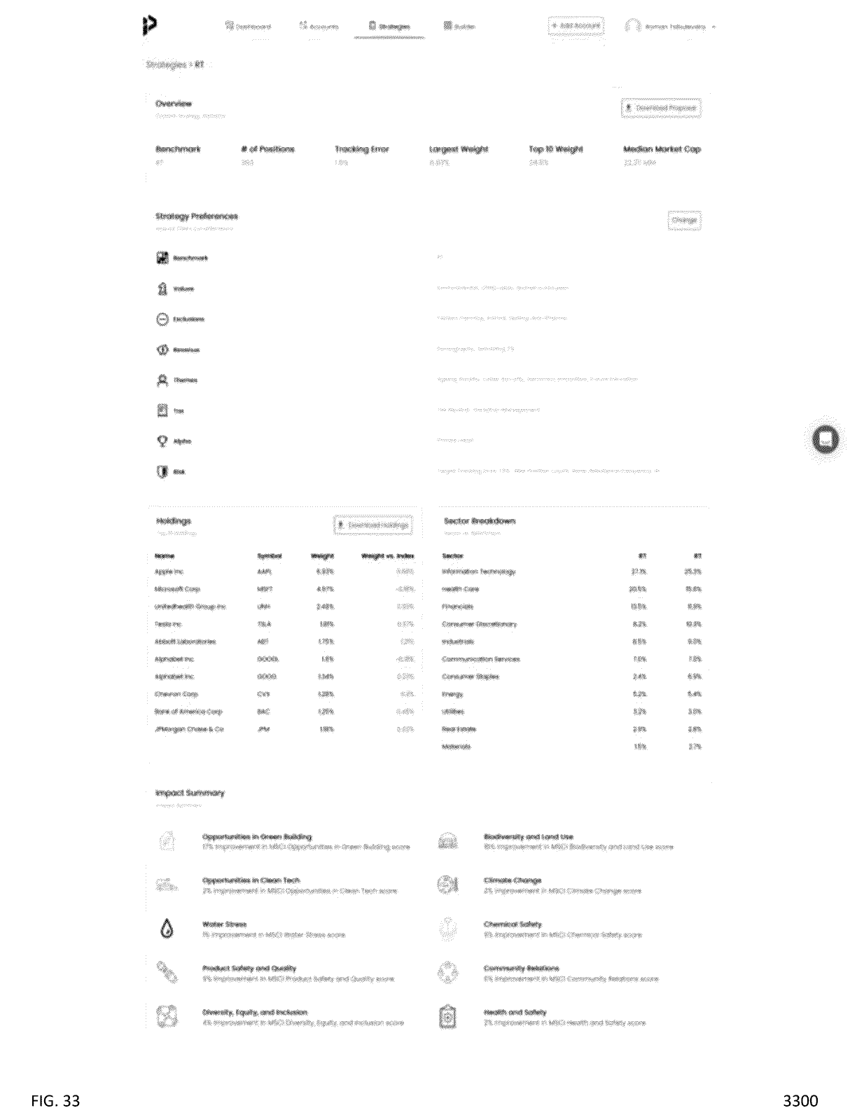

FIG. 32 shows the screenshot of the embodiment of the screen 3200 for naming the set of answers provided by the user according to this disclosure. FIG. 33 shows the screenshot of the embodiment of the screen 3300 with the set of tiles updated with data pursuant to the set of answers provided by the user according to this disclosure. As such, the screen 3200 is presented over the screen 3000 to enable the user to enter (e.g., by typing) the name of the set of answers input into the software wizard, as disclosed herein. Then, as shown in FIG. 33, the user can operate the GUI 200 to select the strategies (preference listing) heading (which may be underlined or otherwise made visually distinct when selected) and present the menu for the strategies heading, where the menu visually indicates that the set of preference listings, as input in the menus above, has been created. The menu presents the set of tiles, each topic dedicated, each having labels with respective data (e.g., numeric values, strings, visual distinction, color-coding, graphics), some presented in tabular formats. The set up tiles is updated dynamically in real-time based on the set of answers previously input into the software wizard, as disclosed herein.

As shown in the screen 3300, when the user activates a user input element (e.g., a button) with a download (or access) proposal label, presented underneath the header in the strategies heading in the top tile (overview), the computing instance generates the customized proposal report based on data input into the software wizard, as disclosed herein. Note that although the user input element is presented internal to the top tile, this configuration is not required and the user input element may be presented external to the top tile. An example of the customized proposal report based on data input into the software wizard, as disclosed herein, is attached herewith. This data includes the set of answers including the set of negative preferences, even when the set of questions in the questionnaire has the logical hierarchy or the informational interdependency, as explained above. The customized proposal report can be generated as a data structure, a file, a data file, and other suitable form factor. The file can include a PDF file, a productivity document file, a word processor file, a presentation file, a spreadsheet file, or another suitable file that can be viewed within or downloaded by the browser running on the computing terminal to be opened by the browser or another application program running on the computing terminal. For example, when the file is a PDF file, then the PDF file may include a set of static data (e.g., text, images) or a set of activatable data (e.g., hyperlinks), whether leading to a webpage (e.g., other than from which the file was downloaded) on activation or another application program on activation (e.g., other than in which the file is being viewed). For example, the file may contain a set of data, such as text, conducive or programmed for an analysis by a generative artificial intelligence (AI) algorithm (e.g., a language model (e.g., large, small)) and a report based on the analysis, where the report may include an automatic summary of the content, whether the analysis and the report is done within the computing instance (e.g., within the application program) or external to the computing instance (e.g., a data feed, an API), where the analysis or the report may be accessed via a chatbot operative within the computing instance (e.g., within the application program) or external to the computing instance (e.g., a data feed, an API). The customized proposal report can enable an action to be taken based on the customized proposal report.

The action can include presenting a link within the browser (e.g., a viewport) running on the computing terminal or causing a button (e.g., within a browser menu) to be presented on the browser running on the computing terminal to view the customized proposal report within or download the customized proposal report by the browser running on the computing terminal. The customized proposal report may include a set of pre-prepared graphics, a table of contents generated based on data input into the software wizard, as explained above, and a set of pre-prepared boilerplate, with a set of alphanumeric data disclosing an investment strategy for the potential client based on data input into the software wizard, as explained above.

The action can include generating a list of ticker symbols and desired quantities or weights based on data input into the wizard, as explained above, to submit an electronic message to a real-time computing system (e.g., a trading engine that can be started, stopped, or paused) remote from the computing instance to act based on the list of ticker symbols and the desired quantities. For example, the real-time computing system may be a HFT computing system (e.g., an API).

The customized proposal report may include the set of alphanumeric data including a first section for the allocation model, as created, or the index identifier or the set of index identifiers, as selected. The first section may include a list of sector identifiers, a set of actual sector weightings for same and a set of proposed sector weightings for same based on optimizing for data input at each of the menu with the values heading, the menu with the themes heading, the menu with the performance and risk heading, and the menu with the taxes heading, together with a sub-set of ticker symbols formed for the allocation model or the index identifier or the set of index identifiers includes that is optimized for data input at each of the menu with the values heading, the menu with the themes heading, the menu with the performance and risk heading, and the menu with the taxes heading.

The customized proposal report may include the set of alphanumeric data including a second section for positive selections in the menu with the values heading, which may follow the first section. The second section may be generated based on positive selections in the menu with the values heading and includes a sub-set of ticker symbols other than a preset of top number of ticker symbols present in the allocation model as created or the index identifier or the set of index identifiers as selected, as that superset of ticker symbols or sets of ticker symbols has been further narrowed, as disclosed herein. The sub-set of ticker symbols other than the preset of top number of ticker symbols is generated based on optimizing the allocation model as created or the index identifier or the set of index identifiers as selected for positive selections in the menu with the values heading with a corresponding weighting adjustment.

The customized proposal report may include the set of alphanumeric data including a third section for data input in the menu with the themes heading, which may follow the second section. The third section may include a sub-set of ticker symbols other than a preset of top number of ticker symbols present in the allocation model as created or the index identifier or the set of index identifiers as selected, as that superset of ticker symbols or sets of ticker symbols. The sub-set of ticker symbols may be generated based on optimizing the allocation model as created or the index identifier or the set of index identifiers as selected for data input in the menu with the themes heading with a corresponding weighting adjustment value.

The customized proposal report may include the set of alphanumeric data including a fourth section for data input in the menu with the value heading, which may follow the third section. The fourth section is generated based on negative selections in the menu with the values heading and includes a category exclusion identifier, a threshold exclusion identifier, and a sub-set of ticker symbols other than a preset of top number of ticker symbols present in the allocation model as created or the index identifier or the set of index identifiers selected, as that superset of ticker symbols or sets of ticker symbols. The sub-set of ticker symbols may be generated based on optimizing the allocation model as created or the index identifier or the set of index identifiers for negative selections in the allocation model as created or the index identifier or the set of index identifiers with a corresponding weighting adjustment value.

The customized proposal report may include the set of alphanumeric data including a fifth section for data input in the menu with the performance heading, which may follow the fourth section. The fifth section may be generated based on an identifier of an optimization algorithm according to which the optimization algorithm optimizes data input into the wizard, as disclosed herein.

As disclosed herein, a score is used, where the score for a given group identifier is derived from a weight participation of each ticker symbol in a group or set multiplied by an individual ticker score for that group (e.g., as provided by a MSCI data set for example). This weighted sum represented when combined represent the total group score for a given group.

As disclosed herein, a model may be used, where the model represents or determines a forecasted estimate of forward expectation for each ticker symbol covered in a pre-defined universe (e.g., the superset). The model may be an optimization model running on or accessible via an optimization engine (e.g., a task-dedicated software logic (e.g., a program) that can be started, stopped, or paused), whether hosted via the computing instance within the computing instance or hosted off the computing instance for the computing instance have access to be used, as disclosed herein.

As disclosed herein, a deviation from a benchmark may include a tracking error. For example, in finance, the tracking error or active risk may be a measure of the risk in an investment portfolio (e.g., a set of ticker symbols) that is due to active management decisions made by the portfolio manager. Therefore, the tracking error may indicate how closely a portfolio (e.g., a set of ticker symbols) follows the index to which the portfolio is benchmarked. For example, one measure may include a standard deviation of a difference between the portfolio (e.g., a set of ticker symbols) and a set of index returns (e.g., a set of alphanumeric values).

As disclosed herein, a trade frequency identifier may represent a maximum period allowed before a rebalance or swapping of a set of ticker symbols is suggested.

As disclosed herein, a minimum cash position may represent or include a minimum percentage a portfolio (e.g., a set of ticker symbols) has to hold in cash to prevent overdrawing fees or use of leverage, as represented by a set of corresponding alphanumerics.

As disclosed herein, a maximum position count may represent or include an upper bound to a number of ticker symbols the optimization algorithm can have as an output.

As disclosed herein, a sector constraint may represent or include a maximum deviation any resulting portfolio (e.g., a set of ticker symbols) can have versus a benchmark as defined by a common global classification standard (e.g., GICS1 Exposure).

As disclosed herein, an industry constrain may represent or include a maximum deviation any resulting portfolio (e.g., a set of ticker symbols) can have versus a benchmark as defined by a common global classification standard (e.g., GICS2 Exposure).

As disclosed herein, a mathematical optimization may include selection of a best element or a set of best elements (e.g., ticker symbols), with regard to some criterion, from some set of available alternatives. For example, the mathematical optimization can be discrete or continuous, whether in real-time or not in real-time. For example, the optimization algorithm may be enabled for maximizing or minimizing a real function by systematically choosing input values from within an allowed set and computing the value of the function. For example, the mathematical optimization may include an optimization software library designed to fit seamlessly into portfolio management workflows and support improved investment decision making processes (e.g., Barra Optimizer on Factset integrated portfolio management application). For example, the mathematical optimization may be via an optimization engine (e.g., a task-dedicated software logic (e.g., a program) that can be started, stopped, or paused), whether hosted via the computing instance within the computing instance or hosted off the computing instance for the computing instance have access to be used, as disclosed herein.

As disclosed herein, a category tag may be a pre-defined grouping that represent a subset of a broader set of grouping defined a data source remote from the virtual computing instance (e.g., my MSCI data source).

As disclosed herein, an underweight candidate may represent or include ticker symbols that the optimization algorithm may be looking to reduce subject to constraints and utilities.

As disclosed herein, an overweight candidate may represent or include ticker symbols that the optimization algorithm may be looking to increase subject to constraints and utilities.

As disclosed herein, an output weight may represent or include a resulting weight of a ticker symbol suggested by completing a portfolio (e.g., a set of ticker symbols) optimization.

As disclosed herein, a weighting adjustment may represent or include an incremental weight calculated as the output weigh or benchmark weigh.

As disclosed herein, an example of an optimization output data model is shown below.

| | Column Name | Data Type |
|---|---|---|
| [symbol] | research_portfolio_id | varchar (50) |
| | datadate | date |
| | barra_id | varchar (10) |
| | quantity | float |
| | value | float |
| | weight | float |

research_portfolio_id—a unique identifier of the optimization that was generated
datadate—a date as of which the optimization was run
barra_id—a unique identifier of the ticker symbol in the optimization
quantity—a number of units (e.g., shares) the optimization would suggest holding in the portfolio (e.g., recited in a relevant data structure)
value—a published value (e.g., a market value) from an external data source (e.g., an electronic trading real-time data service) associated with the ticker symbol as of a date/time (e.g., a market close date/time) on a date provided
weight—a percentage of the value (e.g., a market value) as a fraction of total portfolio value (e.g., recited in a relevant data structure)

As disclosed herein, an example of an optimization meta data model is shown below.

| | Column Name | Data Type |
|---|---|---|
| [symbol] | research_portfolio_id | varchar(50) |
| | datadate | date |
| | [Factor Risk] | float |
| | [Specific Risk] | float |
| | [Total Risk] | float |
| | [Active Factor Risk] | float |
| | [Active Specific Risk] | float |
| | [Active Total Risk] | float |

research_portfolio_id—a unique identifier of the optimization that was generated
datadate—a date as of which the optimization was run
[Factor Risk]—an expected statistical variance of the resulting portfolio as explained by factors in a ticker factor model (e.g., a USMED MSCI Risk Model). Given a weight vector defined in an above paragraph (e.g., 54) (vec_w), a factor exposure matrix defined by the risk model (vec_wf), and a factor covariance matrix specified by the risk model (sigma_f) we calculate factor risk as

$$\vec{w} \cdot \vec{w f} \cdot {\sum }_{F} \cdot \vec{w f} \cdot \vec{w}$$

[Specific Risk]—the expected statistical variance of the resulting portfolio which cannot be explained by factors in a ticker factor model (e.g., a USMED MSCI Risk Model). Given a weight vector defined in an above paragraph (e.g., 54) (vec_w), and a specific covariance matrix specified by the risk_model (sigma_s) we calculate specific risk as

$$\vec{w} \cdot {\sum }_{S} \cdot \vec{w}$$

[Total Risk]—the total statistical variance of the resulting portfolio as defined by a ticker factor model (e.g., a USMED MSCI Risk Model). We calculate this as

$$[ \vec{w} \cdot \vec{w f} \cdot {\sum }_{F} \cdot \vec{w f} \cdot \vec{w} ] + [ \vec{w} \cdot {\sum }_{S} \cdot \vec{w} ]$$

[Active Factor Risk]—the expected statistical variance of the resulting portfolio relative to a benchmark as explained by factors in a ticker factor model (e.g., a USMED MSCI Risk Model). Given a weight vector defined in an above paragraph (e.g., 54) (vec_w), a benchmark weight vector specified by the user (vec_b), a factor exposure matrix defined by the risk model (vec_wf), and a factor covariance matrix specified by the risk model (sigma_f) we calculate active factor risk as

$$( \vec{w} - \vec{b} ) \cdot \vec{w f} \cdot {\sum }_{F} \cdot \vec{w f} \cdot ( \vec{w} - \vec{b} )$$

[Active Specific Risk]—the expected statistical variance of the resulting portfolio relative to a benchmark which cannot be explained by factors in a ticker factor model (e.g., a USMED MSCI Risk Model). Given a weight vector defined in an above paragraph (e.g., 54), (vec_w), a benchmark weight vector specified by the user (vec_b), and a specific covariance matrix specified by the risk_model (sigma_s) we calculate active specific risk as

$$( \vec{w} - \vec{b} ) \cdot {\sum }_{S} \cdot ( \vec{w} - \vec{b} )$$

the expected risk derived from specific stock exposure relative to a benchmark as defined by a ticker factor model (e.g., a USMED MSCI Risk Model)
[Active Total Risk]—the total statistical variance of the resulting portfolio relative to a benchmark as defined by a ticker factor model (e.g., a USMED MSCI Risk Model). We calculate this as

$$[ Active Factor Risk ] + [ Active Specific Risk ]$$

$$[ ( \vec{w} - \vec{b} ) \cdot \vec{w f} \cdot {\sum }_{F} \cdot \vec{w f} \cdot ( \vec{w} - \vec{b} ) ] + [ ( \vec{w} - \vec{b} ) \cdot {\sum }_{S} \cdot ( \vec{w} - \vec{b} ) ]$$

As disclosed herein, when the computing instance (e.g., an Amazon Web Services (AWS) compute instance) receives an optimization request from the computing terminal operated by a user, then the computing instance enables certain specifications (e.g., ticker symbols and corresponding tags and weights) inserted through the GUI 200 and events on a custom calculation grid in the computing instance (e.g., a set of servers with optimization technology installed running on a distributed task (e.g., to be executed synchronous or asynchronous) queue (which may be executed concurrently) software system (e.g., a Celery Task Distribution System) on an in-memory data structure store that is used as a database, cache, message broker, and streaming engine (e.g., Redis) backend). Therefore, an optimization task runs and its data is stored in a set of data models referenced above upon completion. A separate task then runs to create a payload holding certain data required for a proposal report, where this certain data may be copied from the set of data models. For example, the payload may include a data structure (e.g., a file, a data file) in an open standard file format and data interchange format that uses human-readable text to store and transmit data objects consisting of attribute-value pairs and arrays (or other serializable values). For example, the data structure can include a Javascript Object Notation (JSON) file. Therefore, there may be a GUI 200 compatible JSON payload holding a set of data required for a proposal report. The GUI 200 may be listening on an event that the payload has been provided, and dynamically responds by providing the customized proposal report, when the payload is available to serve to the computing terminal. Therefore, the customized proposal report may be generated in a manner efficient for processing throughput and network bandwidth/latency.

Various embodiments of this disclosure may be implemented in a data processing system suitable for storing or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to be-come coupled to other data processing systems or remote printers or storage devices through intervening private or public networks. Modems, cable modems, and Ethernet cards are just a few of the available types of network adapters.

This disclosure may be embodied in a system, a method, or a computer program product. The computer program product may include a computer readable storage medium (or media) having computer readable program instructions thereon for causing a processor to carry out aspects of this disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a port-able compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network or a wireless network. The network may comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of this disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or pro-gram statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of this disclosure.

Aspects of this disclosure are described herein with reference to flowchart illustrations or block diagrams of methods, apparatus (systems), and computer program products according to embodiments of the disclosure. It will be understood that each block of the flowchart illustrations or block diagrams, and combinations of blocks in the flowchart illustrations or block diagrams, can be implemented by computer readable program instructions. The various illustrative logical blocks, modules, circuits, and algorithm steps described in connection with the embodiments disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure.

The flowchart and block diagrams in the Figures illustrate the architecture, functionality, and operation of possible implementations of systems, methods, and computer program products according to various embodiments of this disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Although preferred embodiments have been depicted and described in detail herein, skilled artisans know that various modifications, additions, substitutions and the like can be made without departing from spirit of this disclosure. As such, these are considered to be within the scope of the disclosure, as defined in the following claims.

What is claimed is:

1. A system, comprising:
a data center hosting a computing instance hosting a web portal, a software wizard, and an optimization engine, wherein the web portal hosts the software wizard, wherein the computing instance is programmed to:
host a profile hierarchy including a set of group profiles, a set of first profiles, a set of second profiles, and a set of preference listings, wherein each group profile in the set of group profiles one-to-many corresponds to the set of first profiles and is hierarchically and logically higher than the set of first profiles, wherein each first profile in the set of first profiles one-to-many corresponds to the set of second profiles and is hierarchically and logically higher than the set of second profiles, wherein each second profile in the set of second profiles one-to-many corresponds to the set of preference listings and is hierarchically and logically higher than the set of preference listings;
receive a request to access the web portal from a browser running on a computing terminal external to the data center;
allow the browser to access the web portal responsive to the request;
receive a command to activate the software wizard for a preference listing of the set of preference listings from the browser accessing the web portal, wherein the software wizard contains a set of screens consecutively defining a questionnaire containing a set of questions that is logically hierarchical and informationally interdependent;
receive a set of answers to the set of questions completing the software wizard from the browser accessing the web portal, wherein the set of answers creates an allocation model or selects an index identifier from a set of index identifiers thereby forming a superset of ticker symbols, wherein the set of answers includes a set of positive preferences for the superset of ticker symbols and a set of negative preferences for the superset of ticker symbols;
form a subset of the superset of ticker symbols based on the set of positive preferences for the superset of ticker symbols and the set of negative preferences for the superset of ticker symbols while the browser accesses the web portal;
cause the optimization engine to perform an optimization of the subset based on the set of positive preferences for the superset of ticker symbols and the set of negative preferences for the superset of ticker symbols while the browser accesses the web portal;
generate a data file containing a customized proposal report formed based on the subset being optimized according to the optimization; and
enable the data file to be downloaded by the browser such that the data file can be opened on the computing terminal.

2. The system of claim 1, wherein the customized proposal report is formed based on accessing a JavaScript Object Notation (JSON) file storing a set of data resulting from the subset being optimized according to the optimization.

3. The system of claim 1, wherein the optimization is based on a factor risk expressed as
$$\vec{w} \cdot \vec{w f} \cdot {\sum }_{F} \cdot \vec{w f} \cdot \vec{w} .$$

4. The system of claim 1, wherein the optimization is based on a specific risk expressed as
$$\vec{w} \cdot {\sum }_{S} \cdot \vec{w} .$$

5. The system of claim 1, wherein the optimization is based on a total risk expressed as
$$[ \vec{w} \cdot \vec{w f} \cdot {\sum }_{F} \cdot \vec{w f} \cdot \vec{w} ] + [ \vec{w} \cdot {\sum }_{S} \cdot \vec{w} ] .$$

6. The system of claim 1, wherein the optimization is based on an active factor risk expressed as
$$( \vec{w} - \vec{b} ) \cdot \vec{w f} \cdot {\sum }_{F} \cdot \vec{w f} \cdot ( \vec{w} - \vec{b} ) .$$

7. The system of claim 1, wherein the optimization is based on an active specific risk expressed as
$$( \vec{w} - \vec{b} ) \cdot {\sum }_{S} \cdot ( \vec{w} - \vec{b} ) .$$

8. The system of claim 1, wherein the optimization is based on a risk expressed as
$$[ ( \vec{w} - \vec{b} ) \cdot \vec{w f} \cdot {\sum }_{F} \cdot \vec{w f} \cdot ( \vec{w} - \vec{b} ) ] + [ ( \vec{w} - \vec{b} ) \cdot {\sum }_{S} \cdot ( \vec{w} - \vec{b} ) ] .$$

9. The system of claim 1, wherein the software wizard has six or less screens that are consecutive and topically different from each other.

10. The system of claim 9, wherein at least two of the screens each have a dropdown menu depicting a list of statistically underweight candidates and a list of statistically overweight candidates that are dynamically updated based on at least one positive preference of the set of positive preferences or at least one negative preferences of the set of negative preferences entered as of that respective screen.

11. The system of claim 10, wherein at least three of the screens each have the dropdown menu depicting the list of statistically underweight candidates and the list of statistically overweight candidates that are dynamically updated based on the at least one positive preference of the set of positive preferences or the at least one negative preferences of the set of negative preferences entered as of that respective screen.

12. The system of claim 11, wherein at least four of the screens each have the dropdown menu depicting the list of statistically underweight candidates and the list of statistically overweight candidates that are dynamically updated based on the at least one positive preference of the set of positive preferences or the at least one negative preferences of the set of negative preferences entered as of that respective screen.

13. The system of claim 12, wherein at least five of the screens each have the dropdown menu depicting the list of statistically underweight candidates and the list of statistically overweight candidates that are dynamically updated based on the at least one positive preference of the set of positive preferences or the at least one negative preferences of the set of negative preferences entered as of that respective screen.

14. The system of claim 13, wherein all of the screens each have the dropdown menu depicting the list of statistically underweight candidates and the list of statistically overweight candidates that are dynamically updated based on the at least one positive preference of the set of positive preferences or the at least one negative preferences of the set of negative preferences entered as of that respective screen.

15. The system of claim 1, wherein the set of negative preferences excludes a group of ticker symbols from the subset.

16. The system of claim 1, wherein the optimization engine is internal the web portal.

17. The system of claim 1, wherein the optimization engine is external to the web portal.

18. The system of claim 1, wherein the data file is a Portable Document Format (PDF) file.

19. The system of claim 1, wherein the preference listing is a new preference listing, wherein the computing instance is programmed to receive the command to activate the software wizard for creating the preference listing of the set of preference listings from the browser accessing the web portal.

20. The system of claim 1, wherein the preference listing is a preexisting preference listing, wherein the computing instance is programmed to receive the command to activate the software wizard for editing the preference listing of the set of preference listings from the browser accessing the web portal.
